(19) United States
(12) Patent Application Publication
(10) Pub. No.: US 2025/0358862 A1
(43) Pub. Date: Nov. 20, 2025

(54) TIMING ADVANCE UPDATES ASSOCIATED WITH LAYER 1 AND/OR LAYER 2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/873,402

(22) PCT Filed: Aug. 12, 2022
(86) PCT No.: PCT/CN2022/111994

§ 371 Date: Dec. 10, 2024

(51) Int. Cl. H04W 74/0833; H04W 56/00; H04W 74/00; H04W 74/08

(52) U.S. Cl. CPC H04W 74/0833; H04W 56/0045; H04W 74/006; H04W 74/0891

(57) ABSTRACT

Various aspects of the present disclosure generally relate to wireless communication. In some aspects, a user equipment (UE) may receive a downlink control information (DCI) transmission comprising a physical random access channel (PRACH)-based timing advance (TA) update indication associated with a PRACH-based TA update operation corresponding to at least one deactivated cell. The UE may transmit a PRACH message to the at least one deactivated cell to facilitate updating a TA associated with the at least one deactivated cell. Numerous other aspects are described.

### FIELD OF THE DISCLOSURE

Aspects of the present disclosure generally relate to wireless communication and to techniques and apparatuses for timing advance updates associated with Layer 1 and/or Layer 2 mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive a downlink control information (DCI) transmission comprising a physical random access channel (PRACH)-based timing advance (TA) update indication associated with a PRACH-based TA update operation corresponding to at least one deactivated cell. The one or more processors may be configured to transmit a PRACH message to the at least one deactivated cell to facilitate updating a TA associated with the at least one deactivated cell.

Some aspects described herein relate to a network node for wireless communication. The network node may include a memory and one or more processors coupled to the memory. The one or more processors may be configured to transmit configuration information indicative of a set of candidate deactivated cells. The one or more processors may be configured to transmit a DCI transmission comprising a PRACH-based TA update indication associated with a PRACH-based TA update operation corresponding to at least one deactivated cell of the set of candidate deactivated cells.

Some aspects described herein relate to a UE for wireless communication. The UE may include a memory and one or more processors coupled to the memory.

The one or more processors may be configured to receive a TA command from a network node corresponding to an active cell associated with an active TA group (TAG). The one or more processors may be configured to determine TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG. The one or more processors may be configured to transmit the TA information to the at least one deactivated cell.

Some aspects described herein relate to a UE for wireless communication. The UE may include a memory and one or more processors coupled to the memory. The one or more processors may be configured to obtain a first set of parameter values associated with a first transmission reception point (TRP) of a plurality of TRPs that includes the first TRP and a second TRP, the first TRP corresponding to a first TRP identifier (ID) and the second TRP corresponding to a second TRP ID. The one or more processors may be configured to provide first TA information to the first TRP based on a multi-TRP (mTRP) per-TRP TA adjustment configuration.

Some aspects described herein relate to a network node for wireless communication. The network node may include a memory and one or more processors coupled to the memory. The one or more processors may be configured to transmit a downlink reference signal corresponding to a first set of parameter values associated with a first TRP of a plurality of TRPs that includes the first TRP and a second TRP, the first TRP corresponding to a first TRP ID and the second TRP corresponding to a second TRP ID. The one or more processors may be configured to receive first TA information from a UE based on an mTRP per-TRP TA adjustment configuration.

Some aspects described herein relate to a method of wireless communication performed by a UE. The method may include receiving a DCI transmission comprising a PRACH-based TA update indication associated with a PRACH-based TA update operation corresponding to at least one deactivated cell. The method may include transmitting a PRACH message to the at least one deactivated cell to facilitate updating a TA associated with the at least one deactivated cell.

Some aspects described herein relate to a method of wireless communication performed by a network node. The method may include transmitting configuration information indicative of a set of candidate deactivated cells. The method may include transmitting a DCI transmission comprising a PRACH-based TA update indication associated with a PRACH-based TA update operation corresponding to at least one deactivated cell of the set of candidate deactivated cells.

Some aspects described herein relate to a method of wireless communication performed by a UE. The method may include receiving a TA command from a network node corresponding to an active cell associated with an active TAG. The method may include determining TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG. The method may include transmitting the TA information to the at least one deactivated cell.

Some aspects described herein relate to a method of wireless communication performed by a UE. The method may include obtaining a first set of parameter values associated with a first TRP of a plurality of TRPs that includes the first TRP and a second TRP, the first TRP corresponding to a first TRP ID and the second TRP corresponding to a second TRP ID. The method may include providing first TA information to the first TRP based on an mTRP per-TRP TA adjustment configuration.

Some aspects described herein relate to a method of wireless communication performed by a network node. The method may include transmitting a downlink reference signal corresponding to a first set of parameter values associated with a first TRP of a plurality of TRPs that includes the first TRP and a second TRP, the first TRP corresponding to a first TRP ID and the second TRP corresponding to a second TRP ID. The method may include receiving first TA information from a UE based on an mTRP per-TRP TA adjustment configuration.

Some aspects described herein relate to a non-transitory computer-readable medium that stores a set of instructions for wireless communication by a UE. The set of instructions, when executed by one or more processors of the UE, may cause the UE to receive a DCI transmission comprising a PRACH-based TA update indication associated with a PRACH-based TA update operation corresponding to at least one deactivated cell. The set of instructions, when executed by one or more processors of the UE, may cause the UE to transmit a PRACH message to the at least one deactivated cell to facilitate updating a TA associated with the at least one deactivated cell.

Some aspects described herein relate to a non-transitory computer-readable medium that stores a set of instructions for wireless communication by a network node. The set of instructions, when executed by one or more processors of the network node, may cause the network node to transmit configuration information indicative of a set of candidate deactivated cells. The set of instructions, when executed by one or more processors of the network node, may cause the network node to transmit a DCI transmission comprising a PRACH-based TA update indication associated with a PRACH-based TA update operation corresponding to at least one deactivated cell of the set of candidate deactivated cells.

Some aspects described herein relate to a non-transitory computer-readable medium that stores a set of instructions for wireless communication by a UE. The set of instructions, when executed by one or more processors of the UE, may cause the UE to receive a TA command from a network node corresponding to an active cell associated with an active TAG. The set of instructions, when executed by one or more processors of the UE, may cause the UE to determine TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG. The set of instructions, when executed by one or more processors of the UE, may cause the UE to transmit the TA information to the at least one deactivated cell.

Some aspects described herein relate to a non-transitory computer-readable medium that stores a set of instructions for wireless communication by a UE. The set of instructions, when executed by one or more processors of the UE, may cause the UE to obtain a first set of parameter values associated with a first TRP of a plurality of TRPs that includes the first TRP and a second TRP, the first TRP corresponding to a first TRP ID and the second TRP corresponding to a second TRP ID. The set of instructions, when executed by one or more processors of the UE, may cause the UE to provide first TA information to the first TRP based on an mTRP per-TRP TA adjustment configuration.

Some aspects described herein relate to a non-transitory computer-readable medium that stores a set of instructions for wireless communication by a network node. The set of instructions, when executed by one or more processors of the network node, may cause the network node to transmit a downlink reference signal corresponding to a first set of parameter values associated with a first TRP of a plurality of TRPs that includes the first TRP and a second TRP, the first TRP corresponding to a first TRP ID and the second TRP corresponding to a second TRP ID. The set of instructions, when executed by one or more processors of the network node, may cause the network node to receive first TA information from a UE based on an mTRP per-TRP TA adjustment configuration.

Some aspects described herein relate to an apparatus for wireless communication. The apparatus may include means for receiving a DCI transmission comprising a PRACH-based TA update indication associated with a PRACH-based TA update operation corresponding to at least one deactivated cell. The apparatus may include means for transmitting a PRACH message to the at least one deactivated cell to facilitate updating a TA associated with the at least one deactivated cell.

Some aspects described herein relate to an apparatus for wireless communication. The apparatus may include means for transmitting configuration information indicative of a set of candidate deactivated cells. The apparatus may include means for transmitting a DCI transmission comprising a PRACH-based TA update indication associated with a PRACH-based TA update operation corresponding to at least one deactivated cell of the set of candidate deactivated cells.

Some aspects described herein relate to an apparatus for wireless communication. The apparatus may include means for receiving a TA command from a network node corresponding to an active cell associated with an active TAG. The apparatus may include means for determining TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG. The apparatus may include means for transmitting the TA information to the at least one deactivated cell.

Some aspects described herein relate to an apparatus for wireless communication. The apparatus may include means for obtaining a first set of parameter values associated with a first TRP of a plurality of TRPs that includes the first TRP and a second TRP, the first TRP corresponding to a first TRP ID and the second TRP corresponding to a second TRP ID. The apparatus may include means for providing first TA information to the first TRP based on an mTRP per-TRP TA adjustment configuration.

Some aspects described herein relate to an apparatus for wireless communication. The apparatus may include means for transmitting a downlink reference signal corresponding to a first set of parameter values associated with a first TRP of a plurality of TRPs that includes the first TRP and a second TRP, the first TRP corresponding to a first TRP ID and the second TRP corresponding to a second TRP ID. The apparatus may include means for receiving first TA information from a UE based on an mTRP per-TRP TA adjustment configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4A illustrates an example of a layer 1 and/or layer 2 (L1/L2) inter-cell mobility technique, in accordance with the present disclosure.

FIG. 4B illustrates another example of an L1/L2 inter-cell mobility technique, in accordance with the present disclosure.

FIG. 5 is a diagram illustrating an example associated with timing advance (TA) update associated with L1/L2 mobility, in accordance with the present disclosure.

FIG. 6 is a diagram illustrating an example associated with TA update associated with L1/L2 mobility, in accordance with the present disclosure.

FIG. 7 is a diagram illustrating an example associated with TA update associated with L1/L2 mobility, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

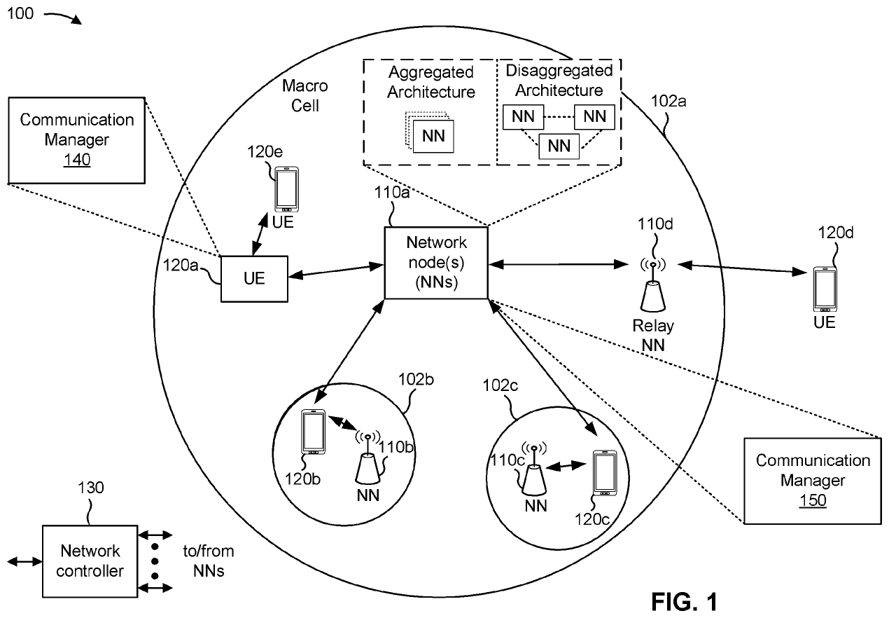

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a downlink control information (DCI) transmission comprising a physical random access channel (PRACH)-based timing advance (TA) update indication associated with a PRACH-based TA update operation corresponding to at least one deactivated cell; and transmit a PRACH message to the at least one deactivated cell to facilitate updating a TA associated with the at least one deactivated cell.

In some aspects, the communication manager 140 may receive a TA command from a network node corresponding to an active cell associated with an active TA group (TAG); determine TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG; and transmit the TA information to the at least one deactivated cell.

In some aspects, the communication manager 140 may obtain a first set of parameter values associated with a first transmission reception point (TRP) of a plurality of TRPs that includes the first TRP and a second TRP, the first TRP corresponding to a first TRP identifier (ID) and the second TRP corresponding to a second TRP ID; and provide first TA information to the first TRP based on a multi-TRP (mTRP) per-TRP TA adjustment configuration.

In some aspects, the network node 110 may include a communication manager 150. As described in more detail elsewhere herein, the communication manager 150 may transmit configuration information indicative of a set of candidate deactivated cells; and transmit a DCI transmission comprising a PRACH-based TA update indication associated with a PRACH-based TA update operation corresponding to at least one deactivated cell of the set of candidate deactivated cells.

In some aspects, the communication manager 150 may transmit a downlink reference signal corresponding to a first set of parameter values associated with a first TRP of a plurality of TRPs that includes the first TRP and a second TRP, the first TRP corresponding to a first TRP ID and the second TRP corresponding to a second TRP ID; and receive first TA information from a UE based on an mTRP per-TRP TA adjustment configuration. Additionally, or alternatively, the communication manager 150 may perform one or more other operations described herein.

As indicated above, FIG. 1 is provided as an example. Other examples may differ from what is described with regard to FIG. 1.

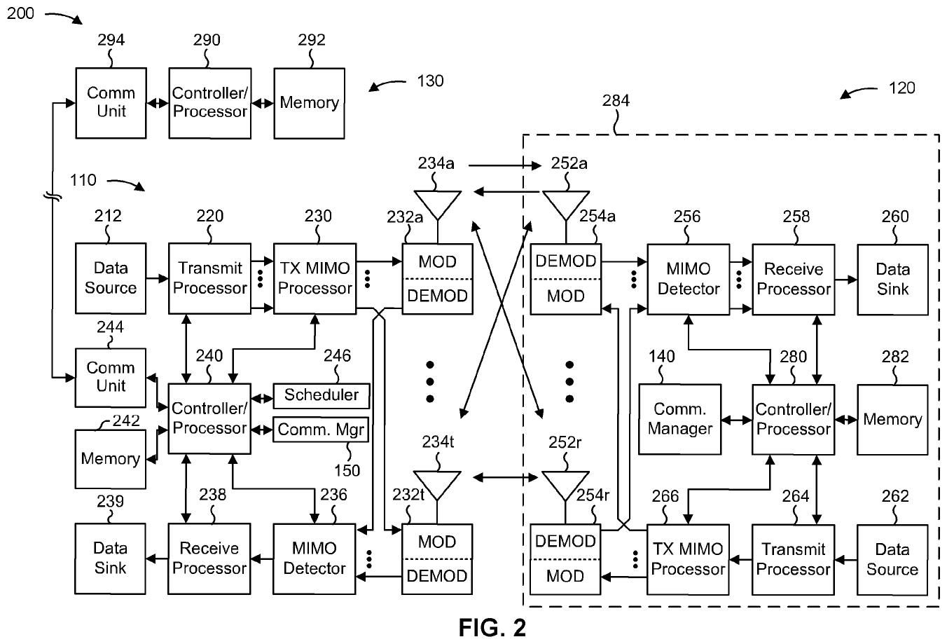

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., 7 antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam ID, spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) DCI to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

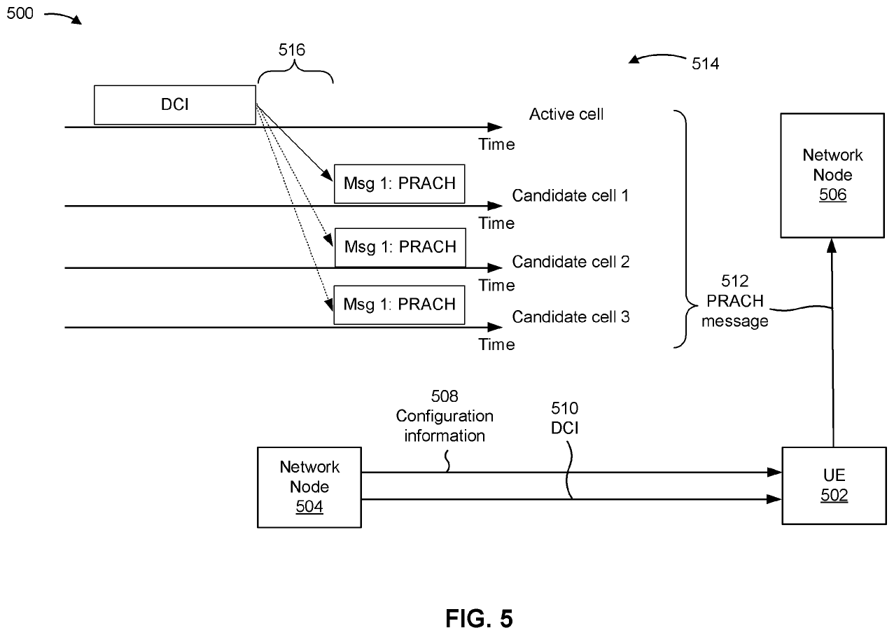

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-14).

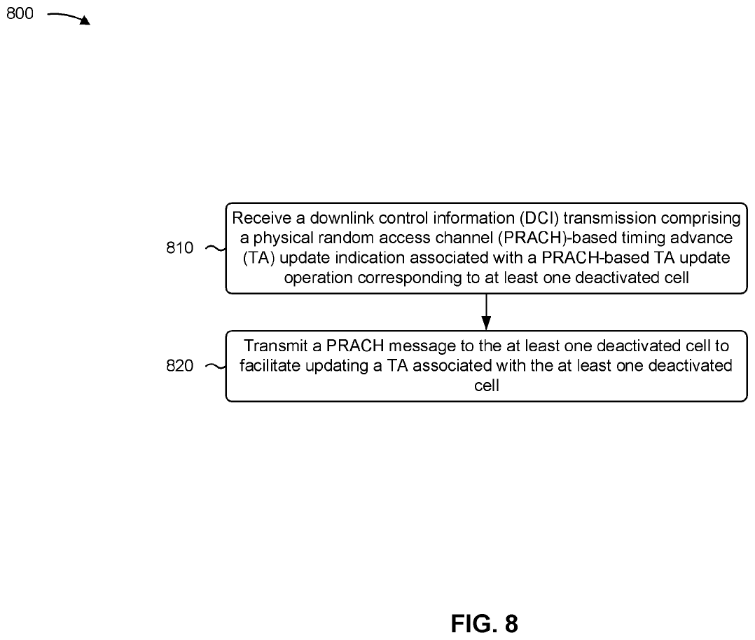

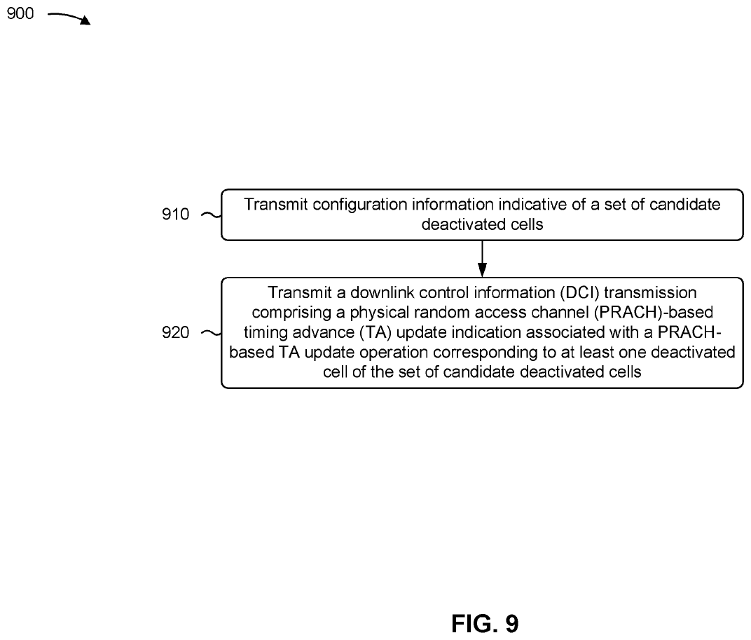

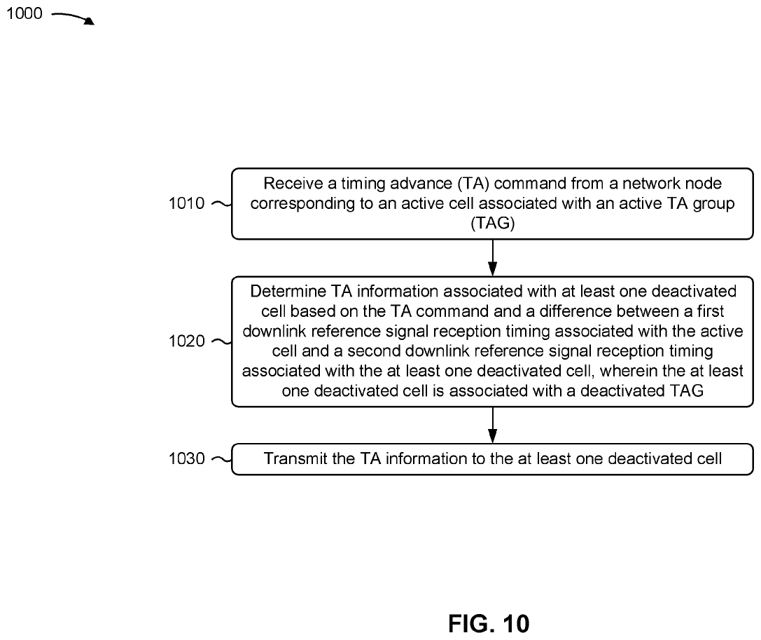

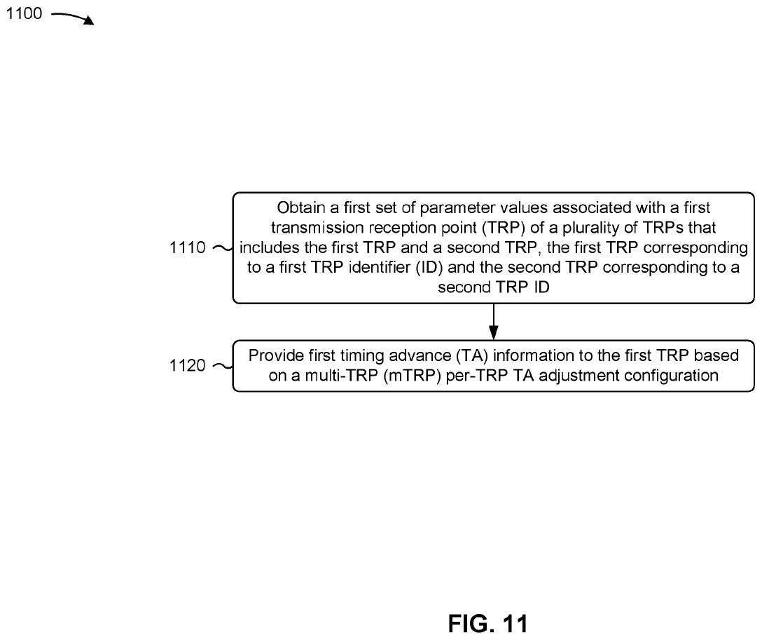

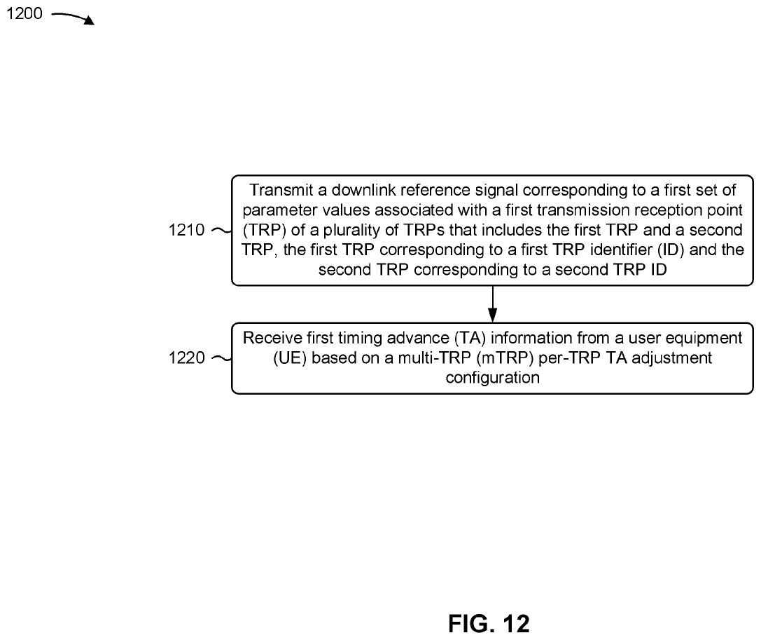

The controller/processor 240 of the network node 110, the controller/processor 280 of the UE 120, and/or any other component(s) of FIG. 2 may perform one or more techniques associated with timing advance updates associated with layer 1 and/or layer 2 mobility, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving a DCI transmission comprising a PRACH-based TA update indication associated with a PRACH-based TA update operation corresponding to at least one deactivated cell; and/or means for transmitting a PRACH message to the at least one deactivated cell to facilitate updating a TA associated with the at least one deactivated cell.

In some aspects, the UE 120 includes means for receiving a TA command from a network node corresponding to an active cell associated with an active TAG; means for determining TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG; and/or means for transmitting the TA information to the at least one deactivated cell.

In some aspects, the UE 120 includes means for obtaining a first set of parameter values associated with a first TRP of a plurality of TRPs that includes the first TRP and a second TRP, the first TRP corresponding to a first TRP ID and the second TRP corresponding to a second TRP ID; and/or means for providing first TA information to the first TRP based on an mTRP per-TRP TA adjustment configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information indicative of a set of candidate deactivated cells; and/or means for transmitting a DCI transmission comprising a PRACH-based TA update indication associated with a PRACH-based TA update operation corresponding to at least one deactivated cell of the set of candidate deactivated cells.

In some aspects, the network node 110 includes means for transmitting a downlink reference signal corresponding to a first set of parameter values associated with a first TRP of a plurality of TRPs that includes the first TRP and a second TRP, the first TRP corresponding to a first TRP ID and the second TRP corresponding to a second TRP ID; and/or means for receiving first TA information from a UE based on an mTRP per-TRP TA adjustment configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

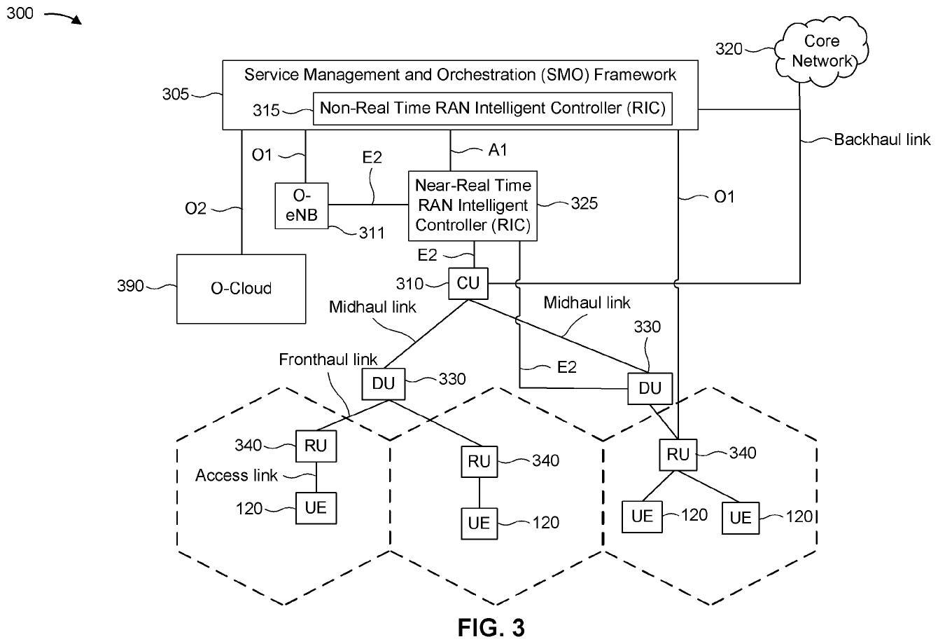

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In a wireless network, such as an NR network, a UE and a network node (e.g., a base station or one or more units or components performing base station functionality) may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation in a relatively high carrier frequency (e.g., within FR2), which may be associated with harsher propagation conditions than comparatively lower carrier frequencies. For example, relative to a sub-6 gigahertz (GHz) band, signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation in a higher carrier frequency is facilitation of efficient (e.g., low latency and low overhead) downlink and/or uplink beam management to support higher layer 1 and/or layer 2 (L1/L2)-centric inter-cell mobility. Accordingly, one goal for L1/L2-centric inter-cell mobility is to enable a UE to perform a cell switch via dynamic control signaling at lower layers (e.g., DCI for L1 signaling or a medium access control (MAC) control element (MAC CE) for L2 signaling) rather than semi-static Layer 3 (L3) RRC signaling in order to reduce latency, reduce overhead, and/or otherwise increase efficiency of the cell switch.

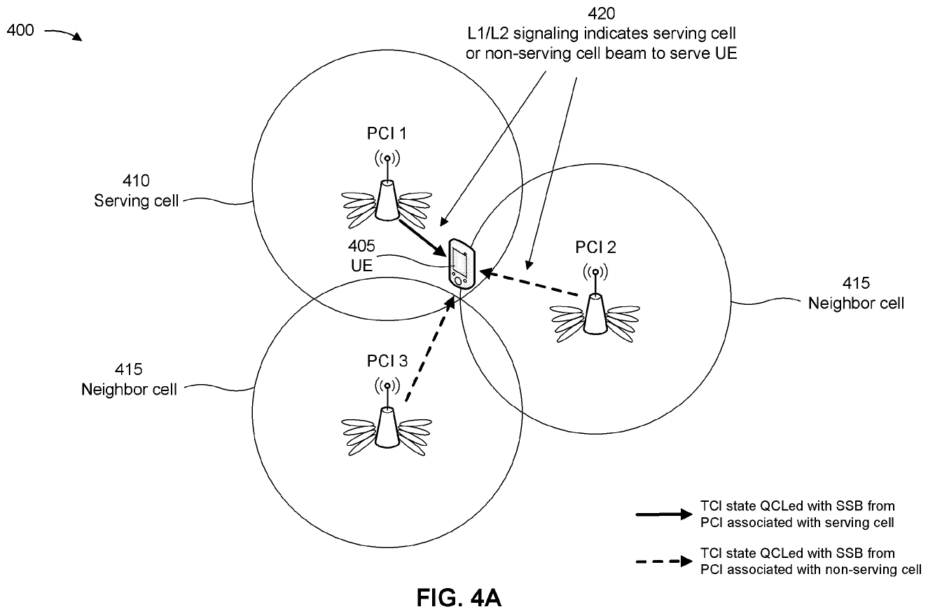

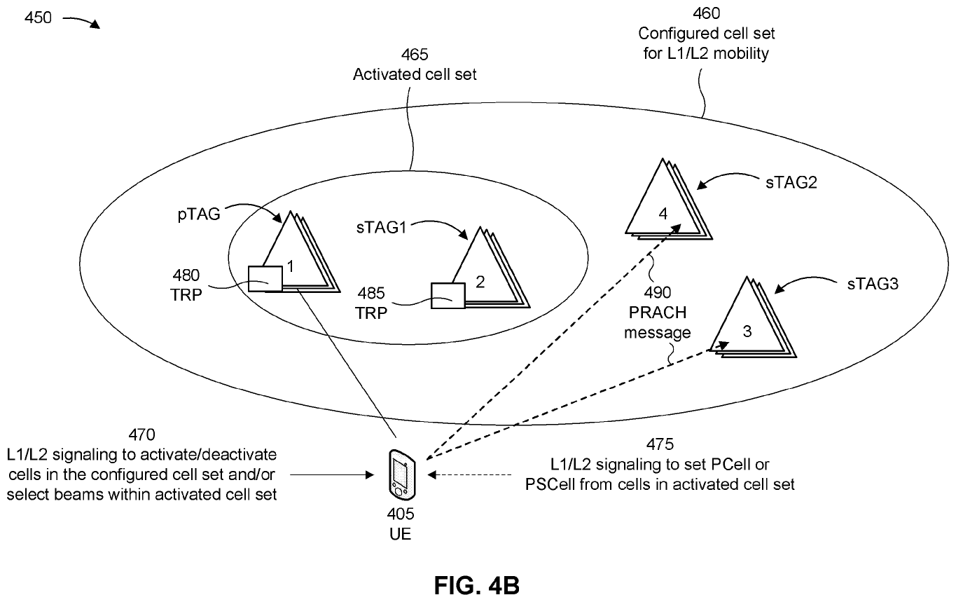

For example, FIG. 4A illustrates an example 400 of a first L1/L2 inter-cell mobility technique, in accordance with the present disclosure. The L1/L2 inter-cell mobility technique may be referred to as inter-cell mobility scheme 1, beam-based inter-cell mobility, dynamic point selection based inter-cell mobility, and/or non-serving cell-based inter-cell mobility, among other examples. As described in further detail herein, the first L1/L2 inter-cell mobility technique may enable a network node to use L1 signaling (e.g., DCI) or L2 signaling (e.g., a medium access control (MAC) control element (MAC CE)) to indicate that a UE 405 is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identifier (PCI) associated with a serving cell. In contrast, in a wireless network that supports the first L1/L2 inter-cell mobility technique (e.g., as shown in FIG. 4A), beam selection for control and data may be expanded to include any beams within a serving cell 410 or one or more non-serving neighbor cells 415 configured for L1/L2 inter-cell mobility.

For example, in the first L1/L2 inter-cell mobility technique shown in FIG. 4A, a UE 405 may be configured with a single serving cell 410, and the UE 405 may be further configured with a neighbor cell set that includes one or more non-serving cells 415 configured for L1/L2 inter-cell mobility. In general, the serving cell 410 and the non-serving cells 415 that are configured for L1/L2 inter-cell mobility may be associated with a common CU and a common DU, or the serving cell 410 and the non-serving cells 415 configured for L1/L2 inter-cell mobility may be associated with a common CU and different DUs. In some aspects, as shown by reference number 420, a base station may trigger L1/L2 inter-cell mobility for a UE using L1/L2 signaling (e.g., DCI or a MAC-CE) that indicates a selected TCI state QCLed with a reference signal (e.g., a synchronization signal block (SSB)) associated with a PCI. For example, in FIG. 4A, the UE may be communicating with the serving cell 410 using a TCI state that is QCLed with an SSB from a PCI associated with the serving cell 410 (e.g., shown as PCI 1 in FIG. 4A), and L1/L2 signaling may trigger inter-cell mobility by indicating that the UE is to switch to communicating using a TCI state that is QCLed with an SSB from a PCI associated with a non-serving neighbor cell 415 (e.g., shown as PCI 2 in FIG. 4A). Accordingly, in the first L1/L2 inter-cell mobility technique, the network node (e.g., the common CU controlling the serving cell 410 and the non-serving neighbor cells 415) may use L1/L2 signaling to select a beam from either the serving cell 410 or a non-serving neighbor cell 415 to serve the UE 405.

In this way, relative to restricting L1/L2 beam selection to beams within the serving cell 410, the first L1/L2 inter-cell mobility technique may be more robust against blocking and may provide more opportunities for higher rank spatial division multiplexing across different cells. However, the first L1/L2 inter-cell mobility technique does not enable support for changing a primary cell (PCell) or a primary secondary cell (PSCell) for a UE 405. Rather, in the first L1/L2 inter-cell mobility technique, triggering a PCell or PSCell change is performed via a legacy L3 handover using RRC signaling. In this respect, the first L1/L2 inter-cell mobility technique is associated with a limitation that L1/L2 signaling can only be used to indicate a beam from the serving cell 410 or a configured neighbor cell 415 while the UE 405 is in the coverage area of the serving cell 410 because L1/L2 signaling cannot be used to change the PCell or PSCell.

Accordingly, FIG. 4B illustrates an example 450 of a second L1/L2 inter-cell mobility technique, in accordance with the present disclosure. The second L1/L2 inter-cell mobility technique may be referred to as inter-cell mobility scheme 2 and/or serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set and/or a deactivated cell set, and/or to indicate a change to a PCell or a PSCell within the activated cell set.

For example, as shown in FIG. 4B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 4B, a network node may configure a cell set 460 for L1/L2 inter-cell mobility (e.g., using radio resource control (RRC) signaling) that includes at least a cell 1 (“1”), a cell 2 (“2”), a cell 3 (“3”), and a cell 4 (“4”). As further shown, an activated cell set 465 may include one or more cells in the configured cell set 460 that are activated and ready to use for data and/or control transfer. The activated cell set 465 may include cell 1 and cell 2, for example. Cell 1 may be a PCell and cell 2 may be a PSCell. Accordingly, in the second L1/L2 inter-cell mobility technique, a deactivated cell set may include one or more cells (cell 3 and cell 4) that are included in the cell set 460 configured for L1/L2 inter-cell mobility but are not included in the activated cell set 465. However, the cells that are included in the deactivated cell set can be readily activated, and thereby added to the activated cell set 465, using L1/L2 signaling. Accordingly, as shown by reference number 470, L1/L2 signaling can be used for mobility management of the activated cell set 465. For example, in some aspects, L1/L2 signaling can be used to activate cells within the configured cell set 460 (e.g., to add cells to the activated cell set 465), to deactivate cells in the activated cell set 465, and/or to select beams within the cells included in the activated cell set 465. In this way, the second L1/L2 inter-cell mobility technique may enable seamless mobility among the cells included in the activated cell set 465 using L1/L2 signaling (e.g., using beam management techniques).

Furthermore, as shown by reference number 475, the second L1/L2 inter-cell mobility technique enables using L1/L2 signaling to set or change a PCell or PSCell from the cells that are included in the activated cell set 465. Additionally, or alternatively, when the cell that is to become the new PCell or PSCell is in the deactivated cell set (e.g., is included in the cell set 460 configured for L1/L2 mobility but not the activated cell set 465), L1/L2 signaling can be used to move the cell from the deactivated cell set to the activated cell set 465 before further L1/L2 signaling is used to set the cell as the new PCell or PSCell. However, in the second L1/L2 inter-cell mobility technique, an L3 handover (using RRC signaling) is used to change the PCell or PSCell when the new PCell or PSCell is not included in the cell set 460 configured for L1/L2 inter-cell mobility. In such cases, RRC signaling associated with the L3 handover may be used to update the cells included in the cell set 460 that is configured for L1/L2 inter-cell mobility.

In some aspects, multiple TRPs 480 and 485 may transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). In some aspects, a TCI state may be used to indicate one or more QCL relationships. A TRP 480 may be configured to individually (for example, using dynamic selection) or jointly (for example, using joint transmission with one or more other TRPs 485) serve traffic to a UE 405. In some aspects, the TRP 480 and/or the TRP 485 may be, include, or be included in, one or more network nodes 110 described above in connection with FIGS. 1 and 2. In some examples, different TRPs 480 and 485 may be included in different base stations and/or other network nodes. In some cases, multiple TRPs 480 and 485 may be included in a single base station and/or other network node. In some cases, a TRP 480 and/or a TRP 485 may be referred to as a network node, a cell, a panel, an antenna array, and/or an array.

The cells in the L1/L2 mobility configured cell set 460 can belong to timing TAGs. “TAG” may refer to a group of cells that have the same (or similar within a threshold value) uplink TA values. For example, a first uplink carrier and a second uplink carrier may have different propagation delays between the UE 405 and the TRP 480 associated with cell 1 and between the UE 405 and the TRP 485. For example, the TRP 480 and the TRP 485 may not be co-located with one another, resulting in different propagation delays for uplink transmissions to reach a respective TRP on the different uplink carriers. As a result, the first uplink carrier and the second uplink carrier may have different timing advance values for uplink transmissions and may belong to different TAGs.

The UE 405 may use a timing advance value for an uplink carrier to transmit an uplink communication on the uplink carrier with a timing that results in synchronization of TTIs with a TRP 480 or 485, to reduce inter-TTI interference.

Uplink carriers can be transmitted asynchronously or synchronously. Two or more uplink carriers are typically synchronous when transmitted in the same subband. Two or more uplink carriers can be transmitted synchronously when a single TA command is used to control their timing. The transmissions of two or more uplink carriers can be considered to be asynchronous with respect to one another when the transmission of one of the carriers lags the transmission of another of the carriers.

Multiple TAGs can be defined for the UE 405, which can be configured for carrier aggregation. A TAG typically comprises one or more uplink carriers controlled by the same TA commands transmitted from a TRP 480 and/or 485. TAGs can be configured by a serving TRP using dedicated signalling. A physical downlink control channel (PDCCH) order directed to an activated secondary cell in a TAG can initiate a RACH procedure that may result in the use of a PRACH. A PDCCH order may be used, for example, after UL and DL resources have been released and the TRP 480 has DL data to send to the UE 405.

When multiple TAGs are defined for the UE 405, timing differences can exist between uplink carriers transmitted by the UE 405, because the one or more TAGS can have received a TA command different from the TA commands received by the other TAGs. TA commands can cause two or more TAGS to have timing offsets that are different from one another, and these timing differences can be characterized as a relative delay between a pair of TAGs, or between corresponding component carriers, subframes, and/or symbols within the pair of TAGs.

In some cases, a group of co-located component carriers (e.g., cells) can belong to a same TAG. As shown, the configured cell set 460 can include multiple non-co-located TAGs. In some cases, each SCell can be configured to a TAG at the time of addition to the configured cell set 460. The TAG assignment can be determined by a network node (e.g., the TRP 480 and/or the TRP 485). TAG assignments can be based on band operation, existence of repeaters, cell location, and/or UE location, among other examples. To determine initial timing for a pTAG (e.g., a TAG containing a PCell), the UE 405 can perform a RACH procedure. To determine initial timing associated with an STAG (e.g., a TAG containing only SCells), the UE 405 can perform a RACH procedure associated with one of the SCells belonging to the sTAG. In some cases, a contention-free RACH procedure can be performed upon reception of a PDCCH order from a network node (e.g., the TRP 480 and/or the TRP 485).

TA information of cells in a TAG containing active cells can be regularly updated through TA MAC CEs transmitted by a network node. However, for TAGs with all deactivated cells, the TA information is typically not regularly updated. Initial TA information associated with deactivated cells can expire or be inaccurate due to UE mobility and/or change of wireless conditions, among other examples. It may be desirable to maintain TA information associated with deactivated cells to facilitate more rapidly obtaining TA information and activating deactivated cells.

Some aspects of the techniques and apparatuses described herein may facilitate TA updating for deactivated cells to facilitate L1/L2 mobility. In some aspects, for example, the definition of “deactivated cell” and/or the definition of “deactivated TAG” may be relaxed to allow for updating a TA associated with a deactivated cell and/or TAG. For example, in some aspects, a UE may receive a DCI transmission that includes a PRACH-based TA update indication associated with a PRACH-based TA update operation corresponding to at least one deactivated cell. The UE may transmit a PRACH message 490 to the at least one deactivated cell to facilitate updating a TA associated with the at least one deactivated cell. In this way, some aspects may provide for PRACH-based TA maintenance associated with deactivated cells.

In some aspects, TA maintenance associated with deactivated cells may be performed without transmitting a PRACH. For example, in some aspects, a UE may derive the TA based on a TA command for a reference active cell as well as the downlink reference signal reception timing difference between the reference active cell and the deactivated cell in a pair of active and deactivated TAGs, respectively. For example, in some aspects, a UE may receive a TA command from a network node corresponding to an active cell associated with an active TAG. The UE may determine TA information associated with at least one deactivated cell based on the TA command and a difference between a first downlink reference signal reception timing associated with the active cell and a second downlink reference signal reception timing associated with the at least one deactivated cell. In this way, some aspects may provide for TA maintenance associated with deactivated cells without increasing signalling overhead associated with PRACH transmissions.

In some aspects, for multi-TRP with per-TRP TA, a UE may perform an autonomous per-TRP TA adjustment. For example, the UE may determine a downlink reference signal reception timing per TRP, based on which the corresponding TA for the same TRP may be autonomously adjusted. In some aspects, the per-TRP autonomous TA adjustment may reuse a same equation for the cell-level autonomous TA adjustment except that the parameters may be TRP specific (e.g., downlink reference signal reception timing, TA value, time alignment amount, and/or TA offset, among other examples). In some aspects, the downlink reference signal reception timing per TRP may be defined as the strongest or earliest path associated with a downlink reference signal that is associated with the corresponding TRP ID. The association between the downlink reference signal reception timing and the corresponding TRP ID may be determined. In this way, some aspects may provide for TA maintenance associated with deactivated cells without increasing signalling overhead associated with PRACH transmissions.

Any one or more of the techniques introduced above may be used to facilitate TA maintenance associated with deactivated cells. As a result, when the deactivated cells are activated in the future, accurate TA information may be already available to use, and thus, the UE may not need to perform RACH at cell activation to obtain TA information. Consequently, some aspects may improve system performance in terms of increased quality of service (QOS), higher throughput, and/or efficiency, among other examples.

As indicated above, FIGS. 4A and 4B are provided as examples. Other examples may differ from what is described with respect to FIGS. 4A and 4B.

FIG. 5 is a diagram illustrating an example 500 associated with TA updates associated with L1/L2 mobility, in accordance with the present disclosure. As shown in FIG. 5, a UE 502 may communicate with a network node 504 and a network node 506. The UE 502 may be, be similar to, include, or be included in, the UE 405 depicted in FIGS. 4A and 4B and/or the UE 120 depicted in FIGS. 1 and 2. The network node 504 and/or the network node 506 may be, be similar to, include, or be included in the TRP 480 and/or TRP 485 depicted in FIG. 4B, the network node 110 depicted in FIGS. 1 and 2, and/or one or more components of the disaggregated base station architecture 300 depicted in FIG. 3. The network node 504 may be associated with a source cell (e.g., a currently active cell with which the UE 502 is in a connected state). The source cell also may be a primary cell (PCell). The network node 506 may be associated with a secondary cell (SCell) (e.g., a deactivated cell). In some aspects, the network node 504 may be, include, or be included in, the network node 506.

As shown by reference number 508, the network node 504 may transmit, and the UE 502 may receive, configuration information. The configuration information may be indicative of a set of candidate deactivated cells (e.g., indicated as “candidate cell 1,” “candidate cell 2,” and “candidate cell 3”) that includes at least one deactivated cell. For example, in some aspects, each candidate cell may be a deactivated cell. In some aspects, the configuration information may be transmitted using a radio resource control (RRC) message.

As shown by reference number 510, the network node 504 may transmit, and the UE 502 may receive, a DCI transmission. The DCI transmission may include a PRACH-based TA update indication associated with a PRACH-based TA update operation corresponding to at least one deactivated cell (e.g., of the set of candidate deactivated cells). In some aspects, the DCI transmission may indicate the at least one deactivated cell. In some aspects, the at least one deactivated cell may include a plurality of deactivated cells. In some aspects, the DCI transmission may indicate at least one synchronization signal block (SSB) associated with the at least one deactivated cell. In some aspects, the PRACH-based TA update indication may indicate a first deactivated cell of the set of candidate deactivated cells. In some aspects, the DCI transmission may include a trigger corresponding to a physical downlink control channel (PDCCH) triggered contention based PRACH operation.

In some aspects, the DCI transmission may include a truncated random access channel (RACH) operation indication that indicates that a RACH operation corresponding to the PRACH-based TA update operation excludes a second RACH message which may be a random access response, a third RACH message which may be a PUSCH, and a fourth RACH message which may schedule a PUSCH. In some aspects, the truncated RACH operation indication includes only one bit of the DCI transmission. The only one bit of the DCI transmission may indicate a first value or a second value. The first value may be indicative of the RACH operation excluding the second RACH message, the third RACH message, and the fourth RACH message, and the second value may be indicative of the RACH operation including the second RACH message, the third RACH message, and the fourth RACH message. In some aspects, the only one bit may correspond to a plurality of deactivated cells of the at least one deactivated cell. In some other aspects, the only one bit may correspond to only one deactivated cell of the at least one deactivated cell.

For example, in some aspects, one bit in the DCI transmission may have a value of “0,” which may indicate that the PRACH transmission is not to be followed by any of the second RACH message, the third RACH message, and the fourth RACH message. The one bit may have a value of “1,” which may indicate that the PRACH transmission is part of a four-step RACH procedure, including any of the second RACH message, the third RACH message, and the fourth RACH message.

In some aspects, the truncated RACH operation indication may be carried in an RRC message and/or a medium access control (MAC) control element (MAC CE).

As shown by reference number 512, the UE 502 may transmit, and the network node 506 (which may be associated with the at least one deactivated cell) may receive, a PRACH message to the at least one deactivated cell. The UE 502 may transmit the PRACH message to facilitate updating a TA associated with the at least one deactivated cell.

In some aspects, the UE 502 may transmit the PRACH message only to an indicated deactivated cell. In some other aspects, an RRC configured candidate cell list may be configured, as indicated above, and the UE 502 may transmit a PRACH message to each of the cells in the list based on an indication, in the DCI, of one of the cells in the list. For example, as shown by the schematic representation 514, the DCI may indicate PRACH for candidate cell 1. Based on candidate cell 2 and candidate cell 3 also being included in a candidate cell list with candidate cell 1, the UE 502 may transmit the PRACH message to candidate cell 2 and candidate cell 3.

In some aspects, any one or more of the aspects described in connection with the PRACH operation for updating TA associated with deactivated cells also may be applicable with respect to PDCCH triggered contention based PRACH, when SSB is not indicated.

In some aspects, a downlink bandwidth part (BWP), associated with transmitting the PRACH message, corresponding to a deactivated cell of the at least one deactivated cell may be based on a downlink BWP associated with a downlink reference signal measurement operation corresponding to the deactivated cell. In some aspects, a power control parameter, for transmitting the PRACH message, corresponding to a deactivated cell of the at least one deactivated cell may be based on a downlink BWP associated with a downlink reference signal measurement operation corresponding to the deactivated cell. In some aspects, the downlink reference signal measurement may include a tracking reference signal, a path-loss reference signal, or a channel state information reference signal (CSI-RS).

In some aspects, the UE 502 may transmit the PRACH message after an expiration of a minimum time 516 associated with the at least one deactivated cell. In some aspects, the minimum time 516 may be based on the at least one deactivated cell having at least one of a different frequency than a frequency of a current active cell or a different subcarrier spacing than a subcarrier spacing of the current active cell. The minimum time 516 may account for additional time for uplink transmission chain activation when the deactivated cell has a different frequency and/or subcarrier spacing than the active (serving) cell.

As indicated above, FIG. 5 is provided as an example. Other examples may differ from what is described with regard to FIG. 5.

In some aspects, a UE may facilitate TA maintenance associated with a deactivated cell without transmitting a PRACH message.

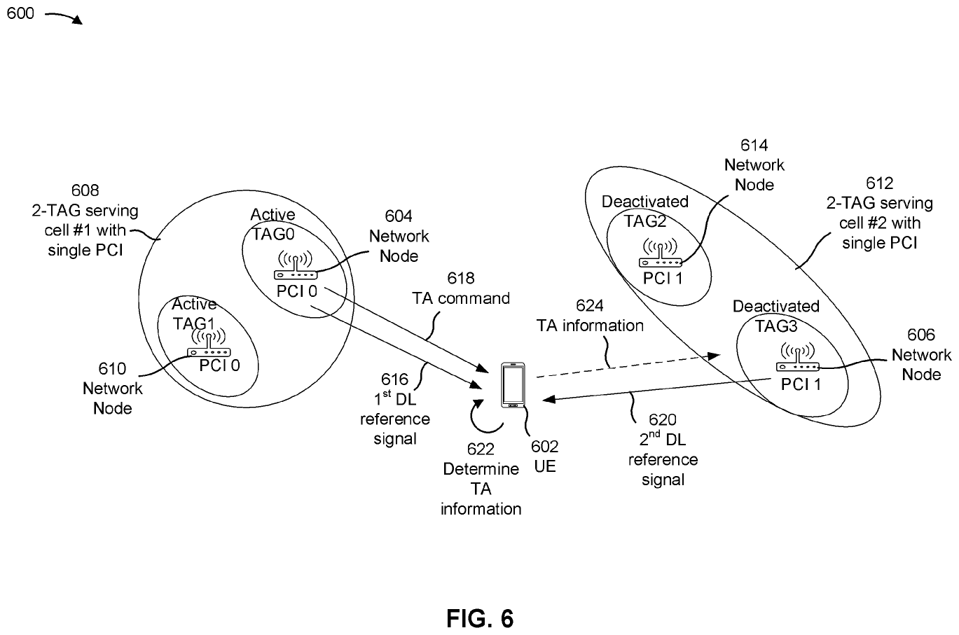

FIG. 6 is a diagram illustrating an example 600 associated with TA update associated with L1/L2 mobility, in accordance with the present disclosure. As shown in FIG. 6, a UE 602 may communicate with a network node 604 and a network node 606. The UE 602 may be, be similar to, include, or be included in, the UE 502 depicted in FIG. 5, the UE 405 depicted in FIGS. 4A and 4B and/or the UE 120 depicted in FIGS. 1 and 2. The network node 604 and/or the network node 606 may be, be similar to, include, or be included in the network node 504 and/or the network node 506 depicted in FIG. 5, the TRP 480 and/or TRP 485 depicted in FIG. 4B, the network node 110 depicted in FIGS. 1 and 2, and/or one or more components of the disaggregated base station architecture 300 depicted in FIG. 3.

The network node 604 may be associated with a serving cell 608 (e.g., a currently active cell with which the UE 602 is in a connected state). The serving cell 608 may have a plurality of associated active TAGs (e.g., two TAGs, as shown). For example, a first active TAG (TAG0) may be associated with the network node 604 and a second active TAG (TAG1) may be associated with a network node 610. The network nodes 604 and 610 may be TRPs associated with the serving cell 608. The network node 604 and the network node 610 may both be associated with a physical cell identifier (PCI) (PCI 0). The network node 606 may be associated with a deactivated cell 612. The deactivated cell 612 may have a plurality of associated deactivated TAGs (e.g., two TAGs, as shown). For example, a first deactivated TAG (TAG2) may be associated with a network node 614 and a second deactivated TAG (TAG3) may be associated with the network node 606. The network nodes 606 and 614 may be TRPs associated with the serving cell 612. The network node 606 and the network node 614 may both be associated with a PCI (PCI 1).

As shown by reference number 616, the network node 604 may transmit, and the UE 602 may receive, a TA command. As shown by reference number 618, the network node 604 may transmit, and the UE 602 may receive, a first downlink reference signal. As shown by reference number 620, the network node 606 may transmit, and the UE 602 may receive, a second downlink reference signal. In some aspects, the first downlink reference signal may include a first QCL source reference signal and the second downlink reference signal may include a second QCL source reference signal. For example, in some aspects, the first QCL source reference signal may include a first SSB and the second QCL source reference signal may include a second SSB.

As shown by reference number 622, the UE 602 may determine TA information associated with at least one deactivated cell (e.g., the cell 612). In some aspects, the UE 602 may determine the TA information based on the TA command and a difference between a first downlink reference signal reception timing (corresponding to the first downlink reference signal) associated with the active cell and a second downlink reference signal reception timing (corresponding to the second downlink reference signal) associated with deactivated cell 612. In some aspects, UE 602 may determine the TA information associated only with the deactivated TAG. In some other aspects, the UE 602 may determine the TA information associated with both TAGs (TAG 2 and TAG 3) associated with the deactivated cell 612.

In some aspects, the UE 602 may determine the TA information based on an association between the first downlink reference signal reception timing and the active TAG, and the association may be based on a mapping between a first QCL source reference signal corresponding to a first TCI state associated with a first control resource set (CORESET) pool index (e.g., a CORESETPoolIndex 0) associated with the active TAG (TAG 1). The UE 602 may determine the information based on an association between second downlink reference signal reception timing and the deactivated TAG, which may be based on a mapping between a second QCL source reference signal corresponding to a second TCI state associated with a second CORESET pool index (e.g., a CORESETPoolIndex 1) associated with the deactivated TAG.

As shown by reference number 624, the UE 602 may transmit, and the network node 606 may receive, the TA information. The network node 606 may use the TA information to update a TA associated with the deactivated TAG (TAG 3).

As indicated above, FIG. 6 is provided as an example. Other examples may differ from what is described with regard to FIG. 6.

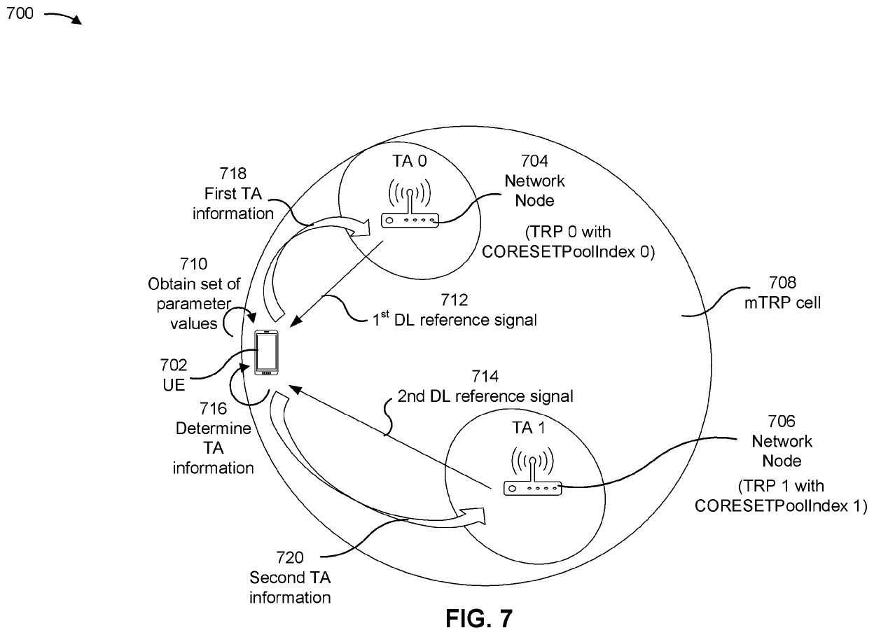

FIG. 7 is a diagram illustrating an example 700 associated with TA updates associated with L1/L2 mobility, in accordance with the present disclosure. As shown in

FIG. 7, a UE 702 may communicate with a network node 704 and a network node 706. The UE 702 may be, be similar to, include, or be included in, the UE 602 depicted in FIG. 6, the UE 502 depicted in FIG. 5, the UE 405 depicted in FIGS. 4A and 4B and/or the UE 120 depicted in FIGS. 1 and 2. The network node 704 and/or the network node 706 may be, be similar to, include, or be included in the network node 504 and/or the network node 506 depicted in FIG. 5, the TRP 480 and/or TRP 485 depicted in FIG. 4B, the network node 110 depicted in FIGS. 1 and 2, and/or one or more components of the disaggregated base station architecture 300 depicted in FIG. 3.

Example 700 illustrates autonomous per-TRP TA updating by the UE 702 in a multiple-TRP (mTRP) configuration. In example 700, the network node 704 may be associated with a cell 708 (e.g., an mTRP cell). The network node 704 may be associated with a first TRP ID (TRP 0) and a first CORESET pool index (CORESETPoolIndex 0) and the network node 706 may be associated with a second TRP ID (TRP 1) and a second CORESET pool index (CORESETPoolIndex 1). The UE 702 may determine TA information associated with each TRP based on a respective downlink reception timing for each cell.

As shown by reference number 710, the UE 702 may obtain a set of parameter values. The set of parameter values may be associated with the TRP 0. The UE 702 also may determine a set of parameter values associated with the TRP 1. For example, as shown by reference number 712, the network node 704 (TRP 0) may transmit, and the UE 702 may receive, a first downlink reference signal (e.g., a first QCL source reference signal). As shown by reference number 714, the network node 706 (TRP 1) may transmit, and the UE 702 may receive, a second downlink reference signal (e.g., a second QCL source reference signal).

As shown by reference number 716, the UE 702 may determine TA information. The TA information may include first TA information associated with the TRP 0 and second TA information associated with the TRP 1. In some aspects, the UE 702 may determine the first TA information associated with the TRP 0 based on a cell-level autonomous TA adjustment equation associated with the first set of parameter values and the second TA information based on the cell-level autonomous TA adjustment equation associated with the second set of parameter values. In some aspects, the first set of parameter values may indicate a first downlink reference signal reception timing, a first TA value, a first time alignment amount, and/or a first TA offset, among other examples. The second set of parameter values may indicate a second downlink reference signal reception timing, a second TA value, a second time alignment amount, and/or a second TA offset, among other examples.

In some aspects, for example, the first downlink reference signal reception timing may include at least one of a strongest path detected based on at least one downlink reference signal associated with the first TRP ID (an ID corresponding to TRP 0) or an earliest path detected based on at least one downlink reference signal associated with the first TRP ID. The second downlink reference signal reception timing may include at least one of a strongest path detected based on at least one downlink reference signal associated with the second TRP ID (an ID corresponding to TRP 1) or an earliest path detected based on at least one downlink reference signal associated with the second TRP ID.

In some aspects, an association between the first downlink reference signal reception timing and the first TRP ID may be based on a mapping between a first QCL source reference signal and a first TCI state and/or a first CORESET pool index associated with the first TRP ID, and an association between the second downlink reference signal reception timing and the second TRP ID may be based on a mapping between a second QCL source reference signal and a second TCI state and/or a second CORESET pool index associated with the second TRP ID. The association between a downlink reference signal and a TRP may be determined via the mapping of the QCL source reference signal in the TCI state(s) activated, indicated, or configured for a TRP or for a CORESETPoolIndex. For example, the downlink reference signal associated with CORESETPoolIndex 0 may be determined as the SSB(s) that are the QCL root source RS(s) or the CSI-RS(s) in the TCI state(s) activated, indicated, or configured for the CORESETPoolIndex 0.

As shown by reference number 718, the UE 702 may transmit, and the network node 704 (TRP 0) may receive, the first TA information and as shown by reference number 720, the UE 702 may transmit, and the network node 706 (TRP 1) may receive, the second TA information. In some aspects, the network node 704 may use the first TA information to update a TA (TA 0) corresponding to the TRP 0, and the network node 706 may use the second TA information to update a TA (TA 1) corresponding to the TRP 1.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 502) performs operations associated with timing advance update associated with L1/L2 mobility.

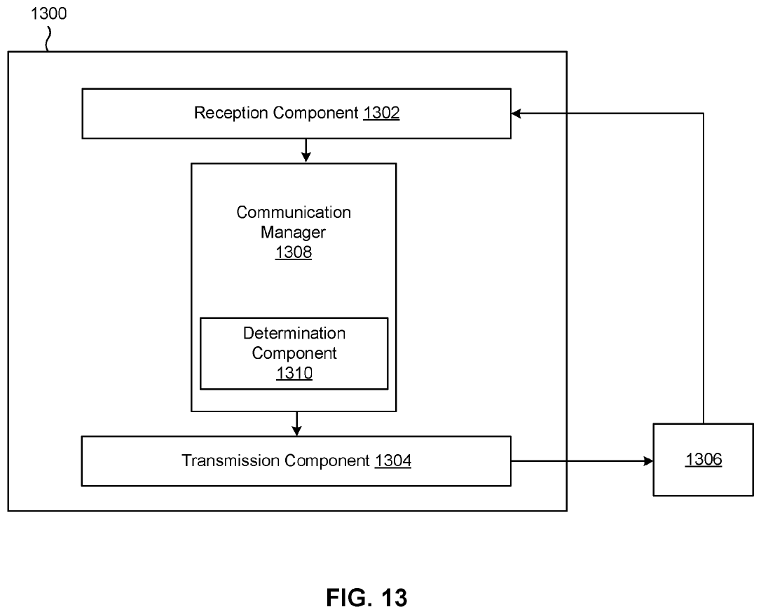

As shown in FIG. 8, in some aspects, process 800 may include receiving a DCI transmission comprising a PRACH-based TA update indication associated with a PRACH-based TA update operation corresponding to at least one deactivated cell (block 810). For example, the UE (e.g., using communication manager 1308 and/or reception component 1302, depicted in FIG. 13) may receive a DCI transmission comprising a PRACH-based TA update indication associated with a PRACH-based TA update operation corresponding to at least one deactivated cell, as described above.

As further shown in FIG. 8, in some aspects, process 800 may include transmitting a PRACH message to the at least one deactivated cell to facilitate updating a TA associated with the at least one deactivated cell (block 820). For example, the UE (e.g., using communication manager 1308 and/or transmission component 1304, depicted in FIG. 13) may transmit a PRACH message to the at least one deactivated cell to facilitate updating a TA associated with the at least one deactivated cell, as described above.

Process 800 may include additional aspects, such as any single aspect or any combination of aspects described below and/or in connection with one or more other processes described elsewhere herein.

In a first aspect, the DCI transmission indicates the at least one deactivated cell. In a second aspect, alone or in combination with the first aspect, the at least one deactivated cell comprises a plurality of deactivated cells. In a third aspect, alone or in combination with one or more of the first and second aspects, the DCI transmission indicates at least one SSB associated with the at least one deactivated cell. In a fourth aspect, alone or in combination with one or more of the first through third aspects, process 800 includes receiving configuration information indicative of a set of candidate deactivated cells that includes the at least one deactivated cell. In a fifth aspect, alone or in combination with the fourth aspect, receiving the configuration information comprises receiving an RRC message that includes the configuration information.

In a sixth aspect, alone or in combination with the fifth aspect, the PRACH-based TA update indication indicates a first deactivated cell of the set of candidate deactivated cells, and transmitting the PRACH message to the at least one deactivated cell comprises transmitting the PRACH message to the first deactivated cell and each other deactivated cell of the set of candidate deactivated cells. In a seventh aspect, alone or in combination with one or more of the first through sixth aspects, the DCI transmission comprises a trigger corresponding to a physical downlink control channel triggered contention based PRACH operation. In an eighth aspect, alone or in combination with the seventh aspect, the DCI transmission does not indicate an SSB associated with the at least one deactivated cell. In a ninth aspect, alone or in combination with the eighth aspect, process 800 includes receiving a truncated RACH operation indication that indicates that a RACH operation corresponding to the PRACH-based TA update operation excludes a second RACH message, a third RACH message, and a fourth RACH message.

In a tenth aspect, alone or in combination with one or more of the first through ninth aspects, the truncated RACH operation indication comprises only one bit of the DCI transmission. In an eleventh aspect, alone or in combination with the tenth aspect, the only one bit of the DCI transmission indicates a first value or a second value, wherein the first value is indicative of the RACH operation excluding the second RACH message, the third RACH message, and the fourth RACH message, and wherein the second value is indicative of the RACH operation including the second RACH message, the third RACH message, and the fourth RACH message. In a twelfth aspect, alone or in combination with the eleventh aspect, the only one bit corresponds to a plurality of deactivated cells of the at least one deactivated cell.

In a thirteenth aspect, alone or in combination with one or more of the eleventh or twelfth aspects, the only one bit corresponds to only one deactivated cell of the at least one deactivated cell. In a fourteenth aspect, alone or in combination with one or more of the eleventh or twelfth aspects, receiving the truncated RACH operation indication comprises receiving a radio resource control message that includes the truncated RACH operation indication.

In a fifteenth aspect, alone or in combination with one or more of the tenth through fourteenth aspects, receiving the truncated RACH operation indication comprises receiving a medium access control control element that includes the truncated RACH operation indication. In a sixteenth aspect, alone or in combination with one or more of the tenth through fourteenth aspects, a downlink BWP corresponding to a deactivated cell of the at least one deactivated cell is based on a downlink BWP associated with a downlink reference signal measurement operation corresponding to the deactivated cell.

In a seventeenth aspect, alone or in combination with one or more of the first through sixteenth aspects, a power control parameter corresponding to a deactivated cell of the at least one deactivated cell is based on a downlink bandwidth part associated with a downlink reference signal measurement operation corresponding to the deactivated cell. In an eighteenth aspect, alone or in combination with one or more of the first through seventeenth aspects, transmitting the PRACH message comprises transmitting the PRACH message after an expiration of a minimum time associated with the at least one deactivated cell. In a nineteenth aspect, alone or in combination with the eighteenth aspect, the minimum time is based on the at least one deactivated cell having at least one of a different frequency than a frequency of a current active cell or a different subcarrier spacing that a subcarrier spacing of the current active cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 504) performs operations associated with timing advance update associated with L1/L2 mobility.

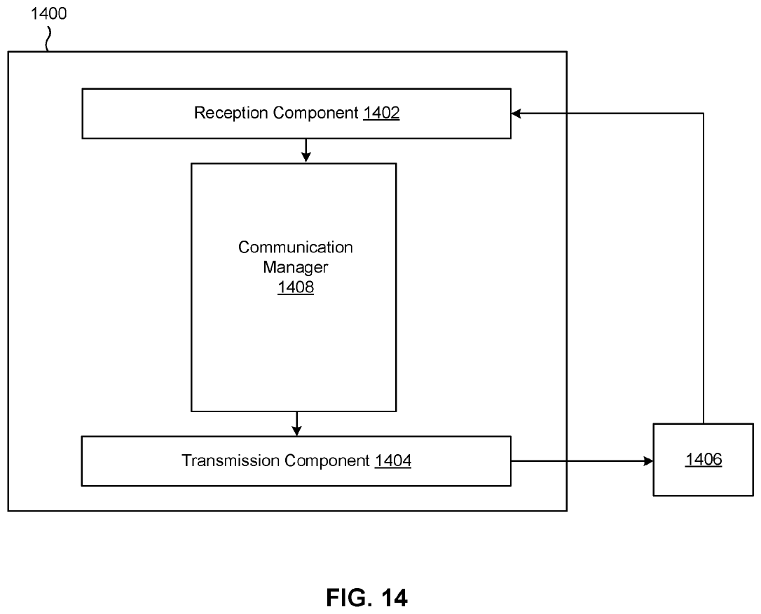

As shown in FIG. 9, in some aspects, process 900 may include transmitting configuration information indicative of a set of candidate deactivated cells (block 910). For example, the network node (e.g., using communication manager 1408 and/or transmission component 1404, depicted in FIG. 14) may transmit configuration information indicative of a set of candidate deactivated cells, as described above.

As further shown in FIG. 9, in some aspects, process 900 may include transmitting a DCI transmission comprising a PRACH-based TA update indication associated with a PRACH-based TA update operation corresponding to at least one deactivated cell of the set of candidate deactivated cells (block 920). For example, the network node (e.g., using communication manager 1408 and/or transmission component 1404, depicted in FIG. 14) may transmit a DCI transmission comprising a PRACH-based TA update indication associated with a PRACH-based TA update operation corresponding to at least one deactivated cell of the set of candidate deactivated cells, as described above.

Process 900 may include additional aspects, such as any single aspect or any combination of aspects described below and/or in connection with one or more other processes described elsewhere herein.

In a first aspect, the DCI transmission indicates the at least one deactivated cell. In a second aspect, alone or in combination with the first aspect, the at least one deactivated cell comprises a plurality of deactivated cells. In a third aspect, alone or in combination with one or more of the first and second aspects, the DCI transmission indicates at least one SSB associated with the at least one deactivated cell. In a fourth aspect, alone or in combination with one or more of the first through third aspects, process 900 includes transmitting configuration information indicative of a set of candidate deactivated cells that includes the at least one deactivated cell. In a fifth aspect, alone or in combination with the fourth aspect, transmitting the configuration information comprises transmitting an RRC message that includes the configuration information. In a sixth aspect, alone or in combination with one or more of the fourth or fifth aspects, the PRACH-based TA update indication indicates a first deactivated cell of the set of candidate deactivated cells. In a seventh aspect, alone or in combination with the sixth aspect, the DCI transmission comprises a trigger corresponding to a PDCCH triggered contention based PRACH operation. In an eighth aspect, alone or in combination with the seventh aspect, the DCI transmission does not indicate an SSB associated with the at least one deactivated cell.

In a ninth aspect, alone or in combination with one or more of the first through eighth aspects, process 900 includes transmitting a truncated RACH operation indication that indicates that a RACH operation corresponding to the PRACH-based TA update operation excludes a second RACH message, a third RACH message, and a fourth RACH message. In a tenth aspect, alone or in combination with the ninth aspect, the truncated RACH operation indication comprises only one bit of the DCI transmission. In an eleventh aspect, alone or in combination with the tenth aspect, the only one bit of the DCI transmission indicates a first value or a second value, wherein the first value is indicative of the RACH operation excluding the second RACH message, the third RACH message, and the fourth RACH message, and wherein the second value is indicative of the RACH operation including the second RACH message, the third RACH message, and the fourth RACH message.

In a twelfth aspect, alone or in combination with one or more of the tenth or eleventh aspects, the only one bit corresponds to a plurality of deactivated cells of the at least one deactivated cell. In a thirteenth aspect, alone or in combination with one or more of the tenth or eleventh aspects, the only one bit corresponds to only one deactivated cell of the at least one deactivated cell. In a fourteenth aspect, alone or in combination with one or more of the tenth through thirteenth aspects, transmitting the truncated RACH operation indication comprises transmitting an RRC message that includes the truncated RACH operation indication. In a fifteenth aspect, alone or in combination with one or more of the tenth through thirteenth aspects, transmitting the truncated RACH operation indication comprises transmitting a MAC CE that includes the truncated RACH operation indication.

In a sixteenth aspect, alone or in combination with one or more of the first through fifteenth aspects, a downlink BWP corresponding to a deactivated cell of the at least one deactivated cell is based on a downlink BWP associated with a downlink reference signal measurement operation corresponding to the deactivated cell. In a seventeenth aspect, alone or in combination with one or more of the first through sixteenth aspects, a power control parameter corresponding to a deactivated cell of the at least one deactivated cell is based on a downlink bandwidth part associated with a downlink reference signal measurement operation corresponding to the deactivated cell. In an eighteenth aspect, alone or in combination with one or more of the first through seventeenth aspects, the configuration information indicates a minimum time after transmission of the DCI transmission before a PRACH message associated with the PRACH-based TA update operation is to be transmitted. In a nineteenth aspect, alone or in combination with the eighteenth aspect, the minimum time is based on the at least one deactivated cell having at least one of a different frequency than a frequency of a current active cell or a different subcarrier spacing that a subcarrier spacing of the current active cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 602) performs operations associated with timing advance update associated with L1/L2 mobility.

As shown in FIG. 10, in some aspects, process 1000 may include receiving a TA command from a network node corresponding to an active cell associated with an active TAG (block 1010). For example, the UE (e.g., using communication manager 1308 and/or reception component 1302, depicted in FIG. 13) may receive a TA command from a network node corresponding to an active cell associated with an active TAG, as described above.

As further shown in FIG. 10, in some aspects, process 1000 may include determining TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG (block 1020). For example, the UE (e.g., using communication manager 1308 and/or determination component 1310, depicted in FIG. 13) may determine TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG, as described above.

As further shown in FIG. 10, in some aspects, process 1000 may include transmitting the TA information to the at least one deactivated cell (block 1030). For example, the UE (e.g., using communication manager 1308 and/or transmission component 1304, depicted in FIG. 13) may transmit the TA information to the at least one deactivated cell, as described above.

Process 1000 may include additional aspects, such as any single aspect or any combination of aspects described below and/or in connection with one or more other processes described elsewhere herein.

In a first aspect, the at least one deactivated cell comprises a deactivated cell associated with a plurality of TAGs that include the deactivated TAG, and determining the TA information comprises determining the TA information associated only with the deactivated TAG. In a second aspect, alone or in combination with the first aspect, an association between the first downlink reference signal reception timing and the active TAG is based on a mapping between a first QCL source reference signal and a first TCI state associated with a first CORESET pool index associated with the active TAG, and an association between the second downlink reference signal reception timing and the deactivated TAG is based on a mapping between a second QCL source reference signal and a second TCI state associated with a second CORESET pool index associated with the deactivated TAG. In a third aspect, alone or in combination with the second aspect, process 1000 includes receiving the first QCL source reference signal and receiving the second QCL source reference signal. In a fourth aspect, alone or in combination with one or more of the second or third aspects, the first QCL source reference signal comprises a first SSB and the second QCL source reference signal comprises a second SSB.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 702) performs operations associated with timing advance update associated with L1/L2 mobility.

As shown in FIG. 11, in some aspects, process 1100 may include obtaining a first set of parameter values associated with a first TRP of a plurality of TRPs that includes the first TRP and a second TRP, the first TRP corresponding to a first TRP ID and the second TRP corresponding to a second TRP ID (block 1110). For example, the UE (e.g., using communication manager 1308 and/or reception component 1302, depicted in FIG. 13) may obtain a first set of parameter values associated with a first TRP of a plurality of TRPs that includes the first TRP and a second TRP, the first TRP corresponding to a first TRP ID and the second TRP corresponding to a second TRP ID, as described above.

As further shown in FIG. 11, in some aspects, process 1100 may include providing first TA information to the first TRP based on an mTRP per-TRP TA adjustment configuration (block 1120). For example, the UE (e.g., using communication manager 1308 and/or transmission component 1304, depicted in FIG. 13) may provide first TA information to the first TRP based on an mTRP per-TRP TA adjustment configuration, as described above.

Process 1100 may include additional aspects, such as any single aspect or any combination of aspects described below and/or in connection with one or more other processes described elsewhere herein.

In a first aspect, process 1100 includes obtaining a second set of parameter values associated with a second TRP of the plurality of TRPs and providing second TA information to the second TRP based on the mTRP per-TRP TA adjustment configuration. In a second aspect, alone or in combination with the first aspect, the first TA information is based on a cell-level autonomous TA adjustment equation associated with the first set of parameter values, and the second TA information is based on the cell-level autonomous TA adjustment equation associated with the second set of parameter values. In a third aspect, alone or in combination with one or more of the first and second aspects, the first set of parameter values indicates at least one of a first downlink reference signal reception timing, a first TA value, a first time alignment amount, or a first TA offset, and the second set of parameter values indicates at least one of a second downlink reference signal reception timing, a second TA value, a second time alignment amount, or a second TA offset.

In a fourth aspect, alone or in combination with the third aspect, the first downlink reference signal reception timing comprises at least one of a strongest path detected based on at least one downlink reference signal associated with the first TRP ID or an earliest path detected based on at least one downlink reference signal associated with the first TRP ID, and the second downlink reference signal reception timing comprises at least one of a strongest path detected based on at least one downlink reference signal associated with the second TRP ID or an earliest path detected based on at least one downlink reference signal associated with the second TRP ID. In a fifth aspect, alone or in combination with the fourth aspect, process 1100 includes receiving the first downlink reference signal, and receiving the second downlink reference signal. In a sixth aspect, alone or in combination with one or more of the fourth or fifth aspects, an association between the first downlink reference signal reception timing and the first TRP ID is based on a mapping between a first QCL source reference signal and a first TCI state associated with the first TRP ID, and an association between the second downlink reference signal reception timing and the second TRP ID is based on a mapping between a second QCL source reference signal and a second TCI state associated with the second TRP ID. In a seventh aspect, alone or in combination with one or more of the fourth through sixth aspects, an association between the first downlink reference signal reception timing and the second TRP ID is based on a mapping between a second QCL source reference signal and a second TCI state associated with a first CORESET pool index, and an association between the second downlink reference signal reception timing and the second TRP ID is based on a mapping between a second QCL source reference signal and a second TCI state associated with a second CORESET pool index.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 704) performs operations associated with timing advance update associated with L1/L2 mobility.

As shown in FIG. 12, in some aspects, process 1200 may include transmitting a downlink reference signal corresponding to a first set of parameter values associated with a first TRP of a plurality of TRPs that includes the first TRP and a second TRP, the first TRP corresponding to a first TRP ID and the second TRP corresponding to a second TRP ID (block 1210). For example, the network node (e.g., using communication manager 1408 and/or transmission component 1404, depicted in FIG. 14) may transmit a downlink reference signal corresponding to a first set of parameter values associated with a first TRP of a plurality of TRPs that includes the first TRP and a second TRP, the first TRP corresponding to a first TRP ID and the second TRP corresponding to a second TRP ID, as described above.

As further shown in FIG. 12, in some aspects, process 1200 may include receiving first TA information from a UE based on an mTRP per-TRP TA adjustment configuration (block 1220). For example, the network node (e.g., using communication manager 1408 and/or reception component 1402, depicted in FIG. 14) may receive first TA information from a UE based on an mTRP per-TRP TA adjustment configuration, as described above.

Process 1200 may include additional aspects, such as any single aspect or any combination of aspects described below and/or in connection with one or more other processes described elsewhere herein.

In a first aspect, the first TA information is based on a cell-level autonomous TA adjustment equation associated with the first set of parameter values. In a second aspect, alone or in combination with the first aspect, the first set of parameter values indicates at least one of a first downlink reference signal reception timing, a first TA value, a first time alignment amount, or a first TA offset. In a third aspect, alone or in combination with the second aspect, the first downlink reference signal reception timing comprises at least one of a strongest path detected based on at least one downlink reference signal associated with the first TRP ID or an earliest path detected based on at least one downlink reference signal associated with the first TRP ID.

In a fourth aspect, alone or in combination with the third aspect, an association between the first downlink reference signal reception timing and the first TRP ID is based on a mapping between a first QCL source reference signal and a first TCI state associated with the first TRP ID. In a fifth aspect, alone or in combination with one or more of the third or fourth aspects, an association between the first downlink reference signal reception timing and the second TRP ID is based on a mapping between a second QCL source reference signal and a second TCI state associated with a first CORESET pool index.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308. The communication manager 1308 may include a determination component 1310.

In some aspects, the apparatus 1300 may be configured to perform one or more operations described herein in connection with FIGS. 5-7. Additionally, or alternatively, the apparatus 1300 may be configured to perform one or more processes described herein, such as process 800 of FIG. 8, process 1000 of FIG. 10, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1308 and/or the reception component 1302 may receive a DCI transmission comprising a PRACH-based TA update indication associated with a PRACH-based TA update operation corresponding to at least one deactivated cell. In some aspects, the communication manager 1308 may include one or more antennas, a modem, a controller/processor, a memory, or a combination thereof, of the UE described in connection with FIG. 2. In some aspects, the communication manager 1308 may include the reception component 1302 and/or the transmission component 1304. In some aspects, the communication manager 1308 may be, be similar to, include, or be included in, the communication manager 140 depicted in FIGS. 1 and 2.

The communication manager 1308 and/or the transmission component 1304 may transmit a PRACH message to the at least one deactivated cell to facilitate updating a TA associated with the at least one deactivated cell. The communication manager 1308 and/or the reception component 1302 may receive configuration information indicative of a set of candidate deactivated cells that includes the at least one deactivated cell. The communication manager 1308 and/or the reception component 1302 may receive a truncated RACH operation indication that indicates that a RACH operation corresponding to the PRACH-based TA update operation excludes a second RACH message, a third RACH message, and a fourth RACH message. The communication manager 1308 and/or the reception component 1302 may receive a TA command from a network node corresponding to an active cell associated with an active TAG.

The communication manager 1308 and/or the determination component 1310 may determine TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG. In some aspects, the determination component 1310 may include one or more antennas, a modem, a controller/processor, a memory, or a combination thereof, of the UE described in connection with FIG. 2. In some aspects, the determination component 1310 may include the reception component 1302 and/or the transmission component 1304.

The communication manager 1308 and/or the transmission component 1304 may transmit the TA information to the at least one deactivated cell. The communication manager 1308 and/or the reception component 1302 may receive the first QCL source reference signal. The communication manager 1308 and/or the reception component 1302 may receive the second QCL source reference signal. The communication manager 1308 and/or the reception component 1302 may obtain a first set of parameter values associated with a first TRP of a plurality of TRPs that includes the first TRP and a second TRP, the first TRP corresponding to a first TRP ID and the second TRP corresponding to a second TRP ID. The communication manager 1308 and/or the transmission component 1304 may provide first TA information to the first TRP based on an mTRP per-TRP TA adjustment configuration. The communication manager 1308 and/or the reception component 1302 may obtain a second set of parameter values associated with a second TRP of the plurality of TRPs. The communication manager 1308 and/or the transmission component 1304 may provide second TA information to the second TRP based on the mTRP per-TRP TA adjustment configuration. The communication manager 1308 and/or the reception component 1302 may receive the first downlink reference signal. The communication manager 1308 and/or the reception component 1302 may receive the second downlink reference signal.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a communication manager 1408.

In some aspects, the apparatus 1400 may be configured to perform one or more operations described herein in connection with FIGS. 5-7. Additionally, or alternatively, the apparatus 1400 may be configured to perform one or more processes described herein, such as process 900 of FIG. 9, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1408 and/or the transmission component 1404 may transmit configuration information indicative of a set of candidate deactivated cells. In some aspects, the communication manager 1408 may include one or more antennas, a modem, a controller/processor, a memory, or a combination thereof, of the network node described in connection with FIG. 2. In some aspects, the communication manager 1408 may include the reception component 1402 and/or the transmission component 1404. In some aspects, the communication manager 1408 may be, be similar to, include, or be included in, the communication manager 150 depicted in FIGS. 1 and 2.

The communication manager 1408 and/or the transmission component 1404 may transmit a DCI transmission comprising a PRACH-based TA update indication associated with a PRACH-based TA update operation corresponding to at least one deactivated cell of the set of candidate deactivated cells. The communication manager 1408 and/or the transmission component 1404 may transmit configuration information indicative of a set of candidate deactivated cells that includes the at least one deactivated cell. The communication manager 1408 and/or the transmission component 1404 may transmit a truncated RACH operation indication that indicates that a RACH operation corresponding to the PRACH-based TA update operation excludes a second RACH message, a third RACH message, and a fourth RACH message. The communication manager 1408 and/or the transmission component 1404 may transmit a downlink reference signal corresponding to a first set of parameter values associated with a first TRP of a plurality of TRPs that includes the first TRP and a second TRP, the first TRP corresponding to a first TRP ID and the second TRP corresponding to a second TRP ID. The communication manager 1408 and/or the reception component 1402 may receive first TA information from a UE based on an mTRP per-TRP TA adjustment configuration.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a user equipment (UE), comprising: receiving a downlink control information (DCI) transmission comprising a physical random access channel (PRACH)-based timing advance (TA) update indication associated with a PRACH-based TA update operation corresponding to at least one deactivated cell; and transmitting a PRACH message to the at least one deactivated cell to facilitate updating a TA associated with the at least one deactivated cell.
Aspect 2: The method of Aspect 1, wherein the DCI transmission indicates the at least one deactivated cell.
Aspect 3: The method of either of Aspects 1 or 2, wherein the at least one deactivated cell comprises a plurality of deactivated cells.
Aspect 4: The method of any of Aspects 1-3, wherein the DCI transmission indicates at least one synchronization signal block (SSB) associated with the at least one deactivated cell.
Aspect 5: The method of any of Aspects 1-4, further comprising receiving configuration information indicative of a set of candidate deactivated cells that includes the at least one deactivated cell.
Aspect 6: The method of Aspect 5, wherein receiving the configuration information comprises receiving a radio resource control message that includes the configuration information.
Aspect 7: The method of either of Aspects 5 or 6, wherein the PRACH-based TA update indication indicates a first deactivated cell of the set of candidate deactivated cells, and wherein transmitting the PRACH message to the at least one deactivated cell comprises transmitting the PRACH message to the first deactivated cell and each other deactivated cell of the set of candidate deactivated cells.
Aspect 8: The method of Aspect 7, wherein the DCI transmission comprises a trigger corresponding to a physical downlink control channel triggered contention based PRACH operation.
Aspect 9: The method of Aspect 8, the DCI transmission does not indicate a synchronization signal block (SSB) associated with the at least one deactivated cell.
Aspect 10: The method of any of Aspects 1-9, further comprising receiving a truncated random access channel (RACH) operation indication that indicates that a RACH operation corresponding to the PRACH-based TA update operation excludes a second RACH message, a third RACH message, and a fourth RACH message.
Aspect 11: The method of Aspect 10, wherein the truncated RACH operation indication comprises only one bit of the DCI transmission.
Aspect 12: The method of Aspect 11, wherein the only one bit of the DCI transmission indicates a first value or a second value, wherein the first value is indicative of the RACH operation excluding the second RACH message, the third RACH message, and the fourth RACH message, and wherein the second value is indicative of the RACH operation including the second RACH message, the third RACH message, and the fourth RACH message.
Aspect 13: The method of either of Aspects 11 or 12, wherein the only one bit corresponds to a plurality of deactivated cells of the at least one deactivated cell.
Aspect 14: The method of either of Aspects 11 or 12, wherein the only one bit corresponds to only one deactivated cell of the at least one deactivated cell.
Aspect 15: The method of any of Aspects 10-14, wherein receiving the truncated RACH operation indication comprises receiving a radio resource control message that includes the truncated RACH operation indication.
Aspect 16: The method of any of Aspects 10-14, wherein receiving the truncated RACH operation indication comprises receiving a medium access control control element that includes the truncated RACH operation indication.
Aspect 17: The method of any of Aspects 1-16, wherein a downlink bandwidth part (BWP) corresponding to a deactivated cell of the at least one deactivated cell is based on a downlink BWP associated with a downlink reference signal measurement operation corresponding to the deactivated cell.
Aspect 18: The method of any of Aspects 1-17, wherein a power control parameter corresponding to a deactivated cell of the at least one deactivated cell is based on a downlink bandwidth part associated with a downlink reference signal measurement operation corresponding to the deactivated cell.
Aspect 19: The method of any of Aspects 1-18, wherein transmitting the PRACH message comprises transmitting the PRACH message after an expiration of a minimum time associated with the at least one deactivated cell.
Aspect 20: The method of Aspect 19, wherein the minimum time is based on the at least one deactivated cell having at least one of a different frequency than a frequency of a current active cell or a different subcarrier spacing that a subcarrier spacing of the current active cell.
Aspect 21: A method of wireless communication performed by a network node, comprising: transmitting configuration information indicative of a set of candidate deactivated cells; and transmitting a downlink control information (DCI) transmission comprising a physical random access channel (PRACH)-based timing advance (TA) update indication associated with a PRACH-based TA update operation corresponding to at least one deactivated cell of the set of candidate deactivated cells.
Aspect 22: The method of Aspect 21, wherein the DCI transmission indicates the at least one deactivated cell.
Aspect 23: The method of either of Aspects 21 or 22, wherein the at least one deactivated cell comprises a plurality of deactivated cells.
Aspect 24: The method of any of Aspects 21-23, wherein the DCI transmission indicates at least one synchronization signal block (SSB) associated with the at least one deactivated cell.
Aspect 25: The method of any of Aspects 21-24, further comprising transmitting configuration information indicative of a set of candidate deactivated cells that includes the at least one deactivated cell.
Aspect 26: The method of Aspect 25, wherein transmitting the configuration information comprises transmitting a radio resource control message that includes the configuration information.
Aspect 27: The method of either of Aspects 25 or 26, wherein the PRACH-based TA update indication indicates a first deactivated cell of the set of candidate deactivated cells.
Aspect 28: The method of Aspect 27, wherein the DCI transmission comprises a trigger corresponding to a physical downlink control channel triggered contention based PRACH operation.
Aspect 29: The method of Aspect 28, the DCI transmission does not indicate a synchronization signal block (SSB) associated with the at least one deactivated cell.
Aspect 30: The method of any of Aspects 21-29, further comprising transmitting a truncated random access channel (RACH) operation indication that indicates that a RACH operation corresponding to the PRACH-based TA update operation excludes a second RACH message, a third RACH message, and a fourth RACH message.
Aspect 31: The method of Aspect 30, wherein the truncated RACH operation indication comprises only one bit of the DCI transmission.
Aspect 32: The method of Aspect 31, wherein the only one bit of the DCI transmission indicates a first value or a second value, wherein the first value is indicative of the RACH operation excluding the second RACH message, the third RACH message, and the fourth RACH message, and wherein the second value is indicative of the RACH operation including the second RACH message, the third RACH message, and the fourth RACH message.
Aspect 33: The method of either of Aspects 31 or 32, wherein the only one bit corresponds to a plurality of deactivated cells of the at least one deactivated cell.
Aspect 34: The method of either of Aspects 31 or 32, wherein the only one bit corresponds to only one deactivated cell of the at least one deactivated cell.
Aspect 35: The method of any of Aspects 30-34, wherein transmitting the truncated RACH operation indication comprises transmitting a radio resource control message that includes the truncated RACH operation indication.
Aspect 36: The method of any of Aspects 30-34, wherein transmitting the truncated RACH operation indication comprises transmitting a medium access control control element that includes the truncated RACH operation indication.
Aspect 37: The method of any of Aspects 21-36, wherein a downlink bandwidth part (BWP) corresponding to a deactivated cell of the at least one deactivated cell is based on a downlink BWP associated with a downlink reference signal measurement operation corresponding to the deactivated cell.
Aspect 38: The method of any of Aspects 21-37, wherein a power control parameter corresponding to a deactivated cell of the at least one deactivated cell is based on a downlink bandwidth part associated with a downlink reference signal measurement operation corresponding to the deactivated cell.
Aspect 39: The method of any of Aspects 21-38, wherein the configuration information indicates a minimum time after transmission of the DCI transmission before a PRACH message associated with the PRACH-based TA update operation is to be transmitted.
Aspect 40: The method of Aspect 39, wherein the minimum time is based on the at least one deactivated cell having at least one of a different frequency than a frequency of a current active cell or a different subcarrier spacing that a subcarrier spacing of the current active cell.
Aspect 41: A method of wireless communication performed by a user equipment (UE), comprising: receiving a timing advance (TA) command from a network node corresponding to an active cell associated with an active TA group (TAG); determining TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG; and transmitting the TA information to the at least one deactivated cell.
Aspect 42: The method of Aspect 41, wherein the at least one deactivated cell comprises a deactivated cell associated with a plurality of TAGs that include the deactivated TAG, and wherein determining the TA information comprises determining the TA information associated only with the deactivated TAG.
Aspect 43: The method of either of Aspects 41 or 42, wherein an association between the first downlink reference signal reception timing and the active TAG is based on a mapping between a first quasi co-location (QCL) source reference signal and a first transmission configuration indicator (TCI) state associated with a first control resource set (CORESET) pool index associated with the active TAG, and wherein an association between the second downlink reference signal reception timing and the deactivated TAG is based on a mapping between a second QCL source reference signal and a second TCI state associated with a second CORESET pool index associated with the deactivated TAG.
Aspect 44: The method of Aspect 43, further comprising: receiving the first QCL source reference signal; and receiving the second QCL source reference signal.
Aspect 45: The method of either of Aspects 43 or 44, wherein the first QCL source reference signal comprises a first synchronization signal block (SSB) and wherein the second QCL source reference signal comprises a second SSB.
Aspect 46: A method of wireless communication performed by a user equipment (UE), comprising: obtaining a first set of parameter values associated with a first transmission reception point (TRP) of a plurality of TRPs that includes the first TRP and a second TRP, the first TRP corresponding to a first TRP identifier (ID) and the second TRP corresponding to a second TRP ID; and providing first timing advance (TA) information to the first TRP based on a multi-TRP (mTRP) per-TRP TA adjustment configuration.
Aspect 47: The method of Aspect 46, further comprising: obtaining a second set of parameter values associated with a second TRP of the plurality of TRPs; and providing second TA information to the second TRP based on the mTRP per-TRP TA adjustment configuration.
Aspect 48: The method of Aspect 47, wherein the first TA information is based on a cell-level autonomous TA adjustment equation associated with the first set of parameter values, and wherein the second TA information is based on the cell-level autonomous TA adjustment equation associated with the second set of parameter values.
Aspect 49: The method of either of Aspects 47 or 48, wherein the first set of parameter values indicates at least one of a first downlink reference signal reception timing, a first TA value, a first time alignment amount, or a first TA offset, and wherein the second set of parameter values indicates at least one of a second downlink reference signal reception timing, a second TA value, a second time alignment amount, or a second TA offset.
Aspect 50: The method of Aspect 49, wherein the first downlink reference signal reception timing comprises at least one of a strongest path detected based on at least one downlink reference signal associated with the first TRP ID or an earliest path detected based on at least one downlink reference signal associated with the first TRP ID, and wherein the second downlink reference signal reception timing comprises at least one of a strongest path detected based on at least one downlink reference signal associated with the second TRP ID or an earliest path detected based on at least one downlink reference signal associated with the second TRP ID.
Aspect 51: The method of Aspect 50, further comprising: receiving the first downlink reference signal; and receiving the second downlink reference signal.
Aspect 52: The method of either of Aspects 50 or 51, wherein an association between the first downlink reference signal reception timing and the first TRP ID is based on a mapping between a first quasi co-location (QCL) source reference signal and a first transmission configuration indicator (TCI) state associated with the first TRP ID, and wherein an association between the second downlink reference signal reception timing and the second TRP ID is based on a mapping between a second QCL source reference signal and a second TCI state associated with the second TRP ID.
Aspect 53: The method of any of Aspects 50-52, wherein an association between the first downlink reference signal reception timing and the second TRP ID is based on a mapping between a second quasi co-location (QCL) source reference signal and a second transmission configuration indicator (TCI) state associated with a first control resource set (CORESET) pool index, and wherein an association between the second downlink reference signal reception timing and the second TRP ID is based on a mapping between a second QCL source reference signal and a second TCI state associated with a second CORESET pool index.
Aspect 54: A method of wireless communication performed by a network node, comprising: transmitting a downlink reference signal corresponding to a first set of parameter values associated with a first transmission reception point (TRP) of a plurality of TRPs that includes the first TRP and a second TRP, the first TRP corresponding to a first TRP identifier (ID) and the second TRP corresponding to a second TRP ID; and receiving first timing advance (TA) information from a user equipment (UE) based on a multi-TRP (mTRP) per-TRP TA adjustment configuration.
Aspect 55: The method of Aspect 54, wherein the first TA information is based on a cell-level autonomous TA adjustment equation associated with the first set of parameter values.
Aspect 56: The method of either of Aspects 54 or 55, wherein the first set of parameter values indicates at least one of a first downlink reference signal reception timing, a first TA value, a first time alignment amount, or a first TA offset.
Aspect 57: The method of Aspect 56, wherein the first downlink reference signal reception timing comprises at least one of a strongest path detected based on at least one downlink reference signal associated with the first TRP ID or an earliest path detected based on at least one downlink reference signal associated with the first TRP ID.
Aspect 58: The method of Aspect 57, wherein an association between the first downlink reference signal reception timing and the first TRP ID is based on a mapping between a first quasi co-location (QCL) source reference signal and a first transmission configuration indicator (TCI) state associated with the first TRP ID.
Aspect 59: The method of either of Aspects 57 or 58, wherein an association between the first downlink reference signal reception timing and the second TRP ID is based on a mapping between a second quasi co-location (QCL) source reference signal and a second transmission configuration indicator (TCI) state associated with a first control resource set (CORESET) pool index.
Aspect 60: An apparatus for wireless communication at a device, comprising a processor; memory coupled with the processor; and instructions stored in the memory and executable by the processor to cause the apparatus to perform the method of one or more of Aspects 1-20.
Aspect 61: A device for wireless communication, comprising a memory and one or more processors coupled to the memory, the one or more processors configured to perform the method of one or more of Aspects 1-20.
Aspect 62: An apparatus for wireless communication, comprising at least one means for performing the method of one or more of Aspects 1-20.
Aspect 63: A non-transitory computer-readable medium storing code for wireless communication, the code comprising instructions executable by a processor to perform the method of one or more of Aspects 1-20.
Aspect 64: A non-transitory computer-readable medium storing a set of instructions for wireless communication, the set of instructions comprising one or more instructions that, when executed by one or more processors of a device, cause the device to perform the method of one or more of Aspects 1-20.
Aspect 65: An apparatus for wireless communication at a device, comprising a processor; memory coupled with the processor; and instructions stored in the memory and executable by the processor to cause the apparatus to perform the method of one or more of Aspects 21-40.
Aspect 66: A device for wireless communication, comprising a memory and one or more processors coupled to the memory, the one or more processors configured to perform the method of one or more of Aspects 21-40.
Aspect 67: An apparatus for wireless communication, comprising at least one means for performing the method of one or more of Aspects 21-40.
Aspect 68: A non-transitory computer-readable medium storing code for wireless communication, the code comprising instructions executable by a processor to perform the method of one or more of Aspects 21-40.
Aspect 69: A non-transitory computer-readable medium storing a set of instructions for wireless communication, the set of instructions comprising one or more instructions that, when executed by one or more processors of a device, cause the device to perform the method of one or more of Aspects 21-40.
Aspect 70: An apparatus for wireless communication at a device, comprising a processor; memory coupled with the processor; and instructions stored in the memory and executable by the processor to cause the apparatus to perform the method of one or more of Aspects 41-45.
Aspect 71: A device for wireless communication, comprising a memory and one or more processors coupled to the memory, the one or more processors configured to perform the method of one or more of Aspects 41-45.
Aspect 72: An apparatus for wireless communication, comprising at least one means for performing the method of one or more of Aspects 41-45.
Aspect 73: A non-transitory computer-readable medium storing code for wireless communication, the code comprising instructions executable by a processor to perform the method of one or more of Aspects 41-45.
Aspect 74: A non-transitory computer-readable medium storing a set of instructions for wireless communication, the set of instructions comprising one or more instructions that, when executed by one or more processors of a device, cause the device to perform the method of one or more of Aspects 41-45.
Aspect 75: An apparatus for wireless communication at a device, comprising a processor; memory coupled with the processor; and instructions stored in the memory and executable by the processor to cause the apparatus to perform the method of one or more of Aspects 46-53.
Aspect 76: A device for wireless communication, comprising a memory and one or more processors coupled to the memory, the one or more processors configured to perform the method of one or more of Aspects 46-53.
Aspect 77: An apparatus for wireless communication, comprising at least one means for performing the method of one or more of Aspects 46-53.
Aspect 78: A non-transitory computer-readable medium storing code for wireless communication, the code comprising instructions executable by a processor to perform the method of one or more of Aspects 46-53.
Aspect 79: A non-transitory computer-readable medium storing a set of instructions for wireless communication, the set of instructions comprising one or more instructions that, when executed by one or more processors of a device, cause the device to perform the method of one or more of Aspects 46-53.
Aspect 80: An apparatus for wireless communication at a device, comprising a processor; memory coupled with the processor; and instructions stored in the memory and executable by the processor to cause the apparatus to perform the method of one or more of Aspects 54-59.
Aspect 81: A device for wireless communication, comprising a memory and one or more processors coupled to the memory, the one or more processors configured to perform the method of one or more of Aspects 54-59.
Aspect 82: An apparatus for wireless communication, comprising at least one means for performing the method of one or more of Aspects 54-59.
Aspect 83: A non-transitory computer-readable medium storing code for wireless communication, the code comprising instructions executable by a processor to perform the method of one or more of Aspects 54-59.
Aspect 84: A non-transitory computer-readable medium storing a set of instructions for wireless communication, the set of instructions comprising one or more instructions that, when executed by one or more processors of a device, cause the device to perform the method of one or more of Aspects 54-59.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a downlink control information (DCI) transmission comprising a physical random access channel (PRACH)-based timing advance (TA) update indication associated with a PRACH-based TA update operation corresponding to at least one deactivated cell; and
transmit a PRACH message to the at least one deactivated cell to facilitate updating a TA associated with the at least one deactivated cell.

2. The UE of claim 1, wherein the DCI transmission indicates the at least one deactivated cell.

3. The UE of claim 1, wherein the at least one deactivated cell comprises a plurality of deactivated cells.

4. The UE of claim 1, wherein the DCI transmission indicates at least one synchronization signal block (SSB) associated with the at least one deactivated cell.

5. The UE of claim 1, wherein the one or more processors are further configured to receive configuration information indicative of a set of candidate deactivated cells that includes the at least one deactivated cell.

6. The UE of claim 5, wherein the one or more processors, to receive the configuration information, are configured to receive a radio resource control message that includes the configuration information.

7. The UE of claim 5, wherein the PRACH-based TA update indication indicates a first deactivated cell of the set of candidate deactivated cells, and wherein the one or more processors, to transmit the PRACH message to the at least one deactivated cell, are configured to transmit the PRACH message to the first deactivated cell and each other deactivated cell of the set of candidate deactivated cells.

8. The UE of claim 7, wherein the DCI transmission comprises a trigger corresponding to a physical downlink control channel triggered contention based PRACH operation.

9. The UE of claim 8, the DCI transmission does not indicate a synchronization signal block (SSB) associated with the at least one deactivated cell.

10. The UE of claim 1, wherein the one or more processors are further configured to receive a truncated random access channel (RACH) operation indication that indicates that a RACH operation corresponding to the PRACH-based TA update operation excludes a second RACH message, a third RACH message, and a fourth RACH message.

11. The UE of claim 10, wherein the truncated RACH operation indication comprises only one bit of the DCI transmission.

12. The UE of claim 11, wherein the only one bit of the DCI transmission indicates a first value or a second value, wherein the first value is indicative of the RACH operation excluding the second RACH message, the third RACH message, and the fourth RACH message, and wherein the second value is indicative of the RACH operation including the second RACH message, the third RACH message, and the fourth RACH message.

13. The UE of claim 11, wherein the only one bit corresponds to a plurality of deactivated cells of the at least one deactivated cell.

14. The UE of claim 11, wherein the only one bit corresponds to only one deactivated cell of the at least one deactivated cell.

15. The UE of claim 10, wherein the one or more processors, to receive the truncated RACH operation indication, are configured to receive a radio resource control message that includes the truncated RACH operation indication.

16. The UE of claim 10, wherein the one or more processors, to receive the truncated RACH operation indication, are configured to receive a medium access control control element that includes the truncated RACH operation indication.

17. The UE of claim 1, wherein a downlink bandwidth part (BWP) corresponding to a deactivated cell of the at least one deactivated cell is based on a downlink BWP associated with a downlink reference signal measurement operation corresponding to the deactivated cell.

18. The UE of claim 1, wherein a power control parameter corresponding to a deactivated cell of the at least one deactivated cell is based on a downlink bandwidth part associated with a downlink reference signal measurement operation corresponding to the deactivated cell.

19. The UE of claim 1, wherein the one or more processors, to transmit the PRACH message, are configured to transmit the PRACH message after an expiration of a minimum time associated with the at least one deactivated cell.

20. The UE of claim 19, wherein the minimum time is based on the at least one deactivated cell having at least one of a different frequency than a frequency of a current active cell or a different subcarrier spacing that a subcarrier spacing of the current active cell.

21. A network node for wireless communication, comprising:
a memory; and
one or more processors, coupled to the memory, configured to:
transmit configuration information indicative of a set of candidate deactivated cells; and
transmit a downlink control information (DCI) transmission comprising a physical random access channel (PRACH)-based timing advance (TA) update indication associated with a PRACH-based TA update operation corresponding to at least one deactivated cell of the set of candidate deactivated cells.

22. The network node of claim 21, wherein the DCI transmission indicates at least one of the at least one deactivated cell or a synchronization signal block (SSB) associated with the at least one deactivated cell.

23. The network node of claim 21, wherein the one or more processors are further configured to transmit configuration information indicative of a set of candidate deactivated cells that includes the at least one deactivated cell, and wherein the PRACH-based TA update indication indicates a first deactivated cell of the set of candidate deactivated cells.

24. The network node of claim 21, wherein the one or more processors are further configured to transmit a truncated random access channel (RACH) operation indication that indicates that a RACH operation corresponding to the PRACH-based TA update operation excludes a second RACH message, a third RACH message, and a fourth RACH message.

25. The network node of claim 24, wherein the truncated RACH operation indication comprises only one bit of the DCI transmission, and wherein the only one bit of the DCI transmission indicates a first value or a second value, wherein the first value is indicative of the RACH operation excluding the second RACH message, the third RACH message, and the fourth RACH message, and wherein the second value is indicative of the RACH operation including the second RACH message, the third RACH message, and the fourth RACH message.

26. The network node of claim 21, wherein the configuration information indicates a minimum time after transmission of the DCI transmission before a PRACH message associated with the PRACH-based TA update operation is to be transmitted, and wherein the minimum time is based on the at least one deactivated cell having at least one of a different frequency than a frequency of a current active cell or a different subcarrier spacing that a subcarrier spacing of the current active cell.

27. A user equipment (UE) for wireless communication, comprising:
a memory; and
one or more processors, coupled to the memory, configured to:
receive a timing advance (TA) command from a network node corresponding to an active cell associated with an active TA group (TAG);
determine TA information associated with at least one deactivated cell based on the TA command and a difference between a first downlink reference signal reception timing associated with the active cell and a second downlink reference signal reception timing associated with the at least one deactivated cell, wherein the at least one deactivated cell is associated with a deactivated TAG; and
transmit the TA information to the at least one deactivated cell.

28. The UE of claim 27, wherein an association between the first downlink reference signal reception timing and the active TAG is based on a mapping between a first quasi co-location (QCL) source reference signal and a first transmission configuration indicator (TCI) state associated with a first control resource set (CORESET) pool index associated with the active TAG, and
wherein an association between the second downlink reference signal reception timing and the deactivated TAG is based on a mapping between a second QCL source reference signal and a second TCI state associated with a second CORESET pool index associated with the deactivated TAG.

29. A user equipment (UE) for wireless communication, comprising:
a memory; and
one or more processors, coupled to the memory, configured to:
obtain a first set of parameter values associated with a first transmission reception point (TRP) of a plurality of TRPs that includes the first TRP and a second TRP, the first TRP corresponding to a first TRP identifier (ID) and the second TRP corresponding to a second TRP ID; and
provide first timing advance (TA) information to the first TRP based on a multi-TRP (mTRP) per-TRP TA adjustment configuration.

30. The UE of claim 29, wherein the one or more processors are further configured to:
obtain a second set of parameter values associated with a second TRP of the plurality of TRPs; and
provide second TA information to the second TRP based on the mTRP per-TRP TA adjustment configuration.
